(19) United States
(12) Patent Application Publication
(10) Pub. No.: US 2026/0156688 A1
(43) Pub. Date: Jun. 4, 2026

(54) COLLISION RESOLUTION FOR MULTIPLE CONTENTION RESOLUTION IDENTITIES IN A RANDOM ACCESS PROCEDURE

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Junyi LI, Greentown, PA (US); Jing JIANG, San Diego, CA (US)

(21) Appl. No.: 18/969,013

(22) Filed: Dec. 4, 2024

(51) Int. Cl. H04W 74/0833; H04W 74/00

(52) U.S. Cl. CPC H04W 74/0841; H04W 74/006

(57) ABSTRACT

Methods, systems, and devices for wireless communications are described. A user equipment (UE) may transmit a random access preamble to a network entity via a random access occasion. The UE may then receive a first downlink message that indicates a temporary radio network identifier that is associated with the random access preamble. The UE may further transmit a random access message that includes the temporary radio network identifier indicated via the first downlink message and information associated with a contention resolution identity associated with the UE. Moreover, the UE may receive a second downlink message. In some cases, the second downlink message may include a radio network identifier corresponding to a contention resolution identity that is associated with the UE or a second UE that is different from the UE. Additionally, or alternatively, the second downlink message may include a request for a retransmission of the random access message.

### FIELD OF TECHNOLOGY

The following relates to wireless communications, including collision resolution for multiple contention resolution identities in a random access procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, to a network entity, a random access preamble via a random access occasion, receiving, based on transmission of the random access preamble, a first downlink message that indicates a temporary radio network identifier that is associated with the random access preamble, transmitting, based on reception of the first downlink message, a random access message that includes the temporary radio network identifier and information associated with a contention resolution identity associated with the UE, and receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

A UE for wireless communications is described. The UE may include one or more memories storing processor executable code, and one or more processors coupled with the one or more memories. The one or more processors may individually or collectively be operable to execute the code to cause the UE to transmit, to a network entity, a random access preamble via a random access occasion, receive, based on transmission of the random access preamble, a first downlink message that indicates a temporary radio network identifier that is associated with the random access preamble, transmit, based on reception of the first downlink message, a random access message that includes the temporary radio network identifier and information associated with a contention resolution identity associated with the UE, and receive, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Another UE for wireless communications is described. The UE may include means for transmitting, to a network entity, a random access preamble via a random access occasion, means for receiving, based on transmission of the random access preamble, a first downlink message that indicates a temporary radio network identifier that is associated with the random access preamble, means for transmitting, based on reception of the first downlink message, a random access message that includes the temporary radio network identifier and information associated with a contention resolution identity associated with the UE, and means for receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

A non-transitory computer-readable medium storing code for wireless communications is described. The code may include instructions executable by one or more processors to transmit, to a network entity, a random access preamble via a random access occasion, receive, based on transmission of the random access preamble, a first downlink message that indicates a temporary radio network identifier that is associated with the random access preamble, transmit, based on reception of the first downlink message, a random access message that includes the temporary radio network identifier and information associated with a contention resolution identity associated with the UE, and receive, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Some examples of the method, UEs, and non-transitory computer-readable medium described herein may further include operations, features, means, or instructions for transmitting, to the network entity, an acknowledgment message in response to reception of the second downlink message, the acknowledgment message indicating the first radio network identifier instead of the temporary radio network identifier based on reception of the second downlink message.

In some examples of the method, UEs, and non-transitory computer-readable medium described herein, receiving the second downlink message may include operations, features, means, or instructions for monitoring for a downlink message that may be associated with the temporary radio network identifier, where reception of the second downlink message may be based on the second downlink message being associated with the temporary radio network identifier.

In some examples of the method, UEs, and non-transitory computer-readable medium described herein, the second downlink message includes a medium access control control element (MAC-CE) and the method, apparatuses, and non-transitory computer-readable medium may include further operations, features, means, or instructions for decoding the MAC-CE based on reception of the second downlink message.

In some examples of the method, UEs, and non-transitory computer-readable medium described herein, the MAC-CE indicates the two or more radio network identifiers corresponding to the two or more contention resolution identities and the method, apparatuses, and non-transitory computer-readable medium may include further operations, features, means, or instructions for identifying that the first radio network identifier that corresponds to the first contention resolution identity may be associated with the information based on decoding the MAC-CE.

In some examples of the method, UEs, and non-transitory computer-readable medium described herein, the second downlink message may be a downlink control information (DCI) message.

A method for wireless communications by a first UE is described. The method may include transmitting, to a network entity, a random access preamble via a random access occasion, receiving, based on transmission of the random access preamble, a first downlink message indicating a temporary radio network identifier that is associated with the random access preamble, transmitting, based on reception of the first downlink message, a random access message that includes the temporary radio network identifier and information associated with a contention resolution identity associated with the first UE, and receiving, based on transmission of the random access message, a second downlink message that includes a first radio network identifier corresponding to a first contention resolution identity that is associated with a second UE that is different from first UE or includes a request for a retransmission of the random access message.

A first UE for wireless communications is described. The first UE may include one or more memories storing processor executable code, and one or more processors coupled with the one or more memories. The one or more processors may individually or collectively be operable to execute the code to cause the first UE to transmit, to a network entity, a random access preamble via a random access occasion, receive, based on transmission of the random access preamble, a first downlink message indicating a temporary radio network identifier that is associated with the random access preamble, transmit, based on reception of the first downlink message, a random access message that includes the temporary radio network identifier and information associated with a contention resolution identity associated with the first UE, and receive, based on transmission of the random access message, a second downlink message that includes a first radio network identifier corresponding to a first contention resolution identity that is associated with a second UE that is different from first UE or includes a request for a retransmission of the random access message.

Another first UE for wireless communications is described. The first UE may include means for transmitting, to a network entity, a random access preamble via a random access occasion, means for receiving, based on transmission of the random access preamble, a first downlink message indicating a temporary radio network identifier that is associated with the random access preamble, means for transmitting, based on reception of the first downlink message, a random access message that includes the temporary radio network identifier and information associated with a contention resolution identity associated with the first UE, and means for receiving, based on transmission of the random access message, a second downlink message that includes a first radio network identifier corresponding to a first contention resolution identity that is associated with a second UE that is different from first UE or includes a request for a retransmission of the random access message.

A non-transitory computer-readable medium storing code for wireless communications is described. The code may include instructions executable by one or more processors to transmit, to a network entity, a random access preamble via a random access occasion, receive, based on transmission of the random access preamble, a first downlink message indicating a temporary radio network identifier that is associated with the random access preamble, transmit, based on reception of the first downlink message, a random access message that includes the temporary radio network identifier and information associated with a contention resolution identity associated with the first UE, and receive, based on transmission of the random access message, a second downlink message that includes a first radio network identifier corresponding to a first contention resolution identity that is associated with a second UE that is different from first UE or includes a request for a retransmission of the random access message.

Some examples of the method, first UEs, and non-transitory computer-readable medium described herein may further include operations, features, means, or instructions for monitoring for a third downlink message in response to the second downlink message including the first radio network identifier corresponding to the first contention resolution identity and receiving, based on monitoring for the third downlink message, the third downlink message that includes a second radio network identifier corresponding to a second contention resolution identity, where the first UE identifies that the second radio network identifier may be associated with the first UE based on a correspondence between the contention resolution identity and the second contention resolution identity.

Some examples of the method, first UEs, and non-transitory computer-readable medium described herein may further include operations, features, means, or instructions for transmitting, to the network entity, an acknowledgment message in response to reception of the third downlink message, the acknowledgment message indicating the second radio network identifier instead of the temporary radio network identifier based on reception of the third downlink message.

Some examples of the method, first UEs, and non-transitory computer-readable medium described herein may further include operations, features, means, or instructions for receiving, via the third downlink message, a MAC-CE indicating the second radio network identifier corresponding to the second contention resolution identity that may be associated with the first UE.

Some examples of the method, first UEs, and non-transitory computer-readable medium described herein may further include operations, features, means, or instructions for monitoring for the third downlink message in response to the second downlink message including the first radio network identifier corresponding to the first contention resolution identity and transmitting, to the network entity, an indication of an expiration of a contention resolution timer based on the UE being unable to receive a respective downlink message that includes a respective radio network identifier corresponding to a respective contention resolution identity that may be associated with the first UE.

In some examples of the method, first UEs, and non-transitory computer-readable medium described herein, the second downlink message includes the request for the retransmission of the random access message and the method, apparatuses, and non-transitory computer-readable medium may include further operations, features, means, or instructions for transmitting, to the network entity in response to the second downlink message, the retransmission of the random access message based on the request for the retransmission.

In some examples of the method, first UEs, and non-transitory computer-readable medium described herein, the second downlink message includes the request for the retransmission of the random access message and the method, apparatuses, and non-transitory computer-readable medium may include further operations, features, means, or instructions for receiving, via the second downlink message, an indication of a set of resources for transmission of the retransmission of the random access message and transmitting, to the network entity in response to the second downlink message and via the set of resources indicated in the second downlink message, the retransmission of the random access message based on reception of the second downlink message.

In some examples of the method, first UEs, and non-transitory computer-readable medium described herein, the second downlink message includes the request for the retransmission of the random access message and the method, apparatuses, and non-transitory computer-readable medium may include further operations, features, means, or instructions for receiving, via the second downlink message, an indication of a reference signal scrambling identifier for inclusion in the retransmission of the random access message and transmitting, to the network entity in response to the second downlink message, the retransmission of the random access message that includes the reference signal scrambling identifier indicated in the second downlink message.

In some examples of the method, first UEs, and non-transitory computer-readable medium described herein, the reference signal scrambling identifier may be a demodulation reference signal (DMRS) scrambling identifier.

In some examples of the method, first UEs, and non-transitory computer-readable medium described herein, the second downlink message and the third downlink message may be DCI messages.

A method for wireless communications by a network entity is described. The method may include receiving, from a UE, a random access preamble via a random access occasion, transmitting, based on reception of the random access preamble, a first downlink message that indicates a temporary radio network identifier that is associated with the random access preamble, receiving, based on transmission of the first downlink message, a random access message that includes the temporary radio network identifier and information associated with a contention resolution identity associated with the UE, and transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

A network entity for wireless communications is described. The network entity may include one or more memories storing processor executable code, and one or more processors coupled with the one or more memories. The one or more processors may individually or collectively be operable to execute the code to cause the network entity to receive, from a UE, a random access preamble via a random access occasion, transmit, based on reception of the random access preamble, a first downlink message that indicates a temporary radio network identifier that is associated with the random access preamble, receive, based on transmission of the first downlink message, a random access message that includes the temporary radio network identifier and information associated with a contention resolution identity associated with the UE, and transmit, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Another network entity for wireless communications is described. The network entity may include means for receiving, from a UE, a random access preamble via a random access occasion, means for transmitting, based on reception of the random access preamble, a first downlink message that indicates a temporary radio network identifier that is associated with the random access preamble, means for receiving, based on transmission of the first downlink message, a random access message that includes the temporary radio network identifier and information associated with a contention resolution identity associated with the UE, and means for transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

A non-transitory computer-readable medium storing code for wireless communications is described. The code may include instructions executable by one or more processors to receive, from a UE, a random access preamble via a random access occasion, transmit, based on reception of the random access preamble, a first downlink message that indicates a temporary radio network identifier that is associated with the random access preamble, receive, based on transmission of the first downlink message, a random access message that includes the temporary radio network identifier and information associated with a contention resolution identity associated with the UE, and transmit, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Some examples of the method, network entities, and non-transitory computer-readable medium described herein may further include operations, features, means, or instructions for receiving, from the UE, an acknowledgment message in response to transmission of the second downlink message, the acknowledgment message indicating the first radio network identifier instead of the temporary radio network identifier based on transmission of the second downlink message.

In some examples of the method, network entities, and non-transitory computer-readable medium described herein, the second downlink message includes a MAC-CE.

In some examples of the method, network entities, and non-transitory computer-readable medium described herein, the MAC-CE indicates the two or more radio network identifiers corresponding to the two or more contention resolution identities.

In some examples of the method, network entities, and non-transitory computer-readable medium described herein, the second downlink message may be a DCI message.

A method for wireless communications by a network entity is described. The method may include receiving, from a first UE, a random access preamble via a random access occasion, transmitting, based on reception of the random access preamble, a first downlink message indicating a temporary radio network identifier that is associated with the random access preamble, receiving, based on transmission of the first downlink message, a random access message that includes the temporary radio network identifier and information associated with a contention resolution identity associated with the first UE, and transmitting, based on reception of the random access message, a second downlink message that includes a first radio network identifier corresponding to a first contention resolution identity that is associated with a second UE that is different from first UE or includes a request for a retransmission of the random access message.

A network entity for wireless communications is described. The network entity may include one or more memories storing processor executable code, and one or more processors coupled with the one or more memories. The one or more processors may individually or collectively be operable to execute the code to cause the network entity to receive, from a first UE, a random access preamble via a random access occasion, transmit, based on reception of the random access preamble, a first downlink message indicating a temporary radio network identifier that is associated with the random access preamble, receive, based on transmission of the first downlink message, a random access message that includes the temporary radio network identifier and information associated with a contention resolution identity associated with the first UE, and transmit, based on reception of the random access message, a second downlink message that includes a first radio network identifier corresponding to a first contention resolution identity that is associated with a second UE that is different from first UE or includes a request for a retransmission of the random access message.

Another network entity for wireless communications is described. The network entity may include means for receiving, from a first UE, a random access preamble via a random access occasion, means for transmitting, based on reception of the random access preamble, a first downlink message indicating a temporary radio network identifier that is associated with the random access preamble, means for receiving, based on transmission of the first downlink message, a random access message that includes the temporary radio network identifier and information associated with a contention resolution identity associated with the first UE, and means for transmitting, based on reception of the random access message, a second downlink message that includes a first radio network identifier corresponding to a first contention resolution identity that is associated with a second UE that is different from first UE or includes a request for a retransmission of the random access message.

A non-transitory computer-readable medium storing code for wireless communications is described. The code may include instructions executable by one or more processors to receive, from a first UE, a random access preamble via a random access occasion, transmit, based on reception of the random access preamble, a first downlink message indicating a temporary radio network identifier that is associated with the random access preamble, receive, based on transmission of the first downlink message, a random access message that includes the temporary radio network identifier and information associated with a contention resolution identity associated with the first UE, and transmit, based on reception of the random access message, a second downlink message that includes a first radio network identifier corresponding to a first contention resolution identity that is associated with a second UE that is different from first UE or includes a request for a retransmission of the random access message.

Some examples of the method, network entities, and non-transitory computer-readable medium described herein may further include operations, features, means, or instructions for transmitting, based on the second downlink message including the first radio network identifier corresponding to the first contention resolution identity, a third downlink message that includes a second radio network identifier corresponding to a second contention resolution identity, where the second radio network identifier may be associated with the first UE based on a correspondence between the contention resolution identity and the second contention resolution identity.

Some examples of the method, network entities, and non-transitory computer-readable medium described herein may further include operations, features, means, or instructions for receiving, from the first UE, an acknowledgment message in response to transmission of the third downlink message, the acknowledgment message indicating the second radio network identifier instead of the temporary radio network identifier based on reception of the third downlink message.

Some examples of the method, network entities, and non-transitory computer-readable medium described herein may further include operations, features, means, or instructions for transmitting, via the third downlink message, a MAC-CE indicating the second radio network identifier corresponding to the second contention resolution identity that may be associated with the first UE.

Some examples of the method, network entities, and non-transitory computer-readable medium described herein may further include operations, features, means, or instructions for receiving, from the first UE and in response to the second downlink message including the first radio network identifier corresponding to the first contention resolution identity, an indication of an expiration of a contention resolution timer based on the UE being unable to receive a respective downlink message that includes a respective radio network identifier corresponding to a respective contention resolution identity that may be associated with the first UE.

In some examples of the method, network entities, and non-transitory computer-readable medium described herein, the second downlink message includes the request for the retransmission of the random access message and the method, apparatuses, and non-transitory computer-readable medium may include further operations, features, means, or instructions for receiving, from the first UE in response to the second downlink message, the retransmission of the random access message based on the request for the retransmission.

In some examples of the method, network entities, and non-transitory computer-readable medium described herein, the second downlink message includes the request for the retransmission of the random access message and the method, apparatuses, and non-transitory computer-readable medium may include further operations, features, means, or instructions for transmitting, via the second downlink message, an indication of a set of resources for transmission of the retransmission of the random access message and receiving, from the first UE in response to the second downlink message and via the set of resources indicated in the second downlink message, the retransmission of the random access message based on reception of the second downlink message.

In some examples of the method, network entities, and non-transitory computer-readable medium described herein, the second downlink message includes the request for the retransmission of the random access message and the method, apparatuses, and non-transitory computer-readable medium may include further operations, features, means, or instructions for transmitting, via the second downlink message, an indication of a reference signal scrambling identifier for inclusion in the retransmission of the random access message and receiving, from the first UE in response to the second downlink message, the retransmission of the random access message that includes the reference signal scrambling identifier indicated in the second downlink message.

In some examples of the method, network entities, and non-transitory computer-readable medium described herein, the reference signal scrambling identifier may be a DMRS scrambling identifier.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show an example of a wireless communications system that supports collision resolution for multiple contention resolution identities in a random access procedure in accordance with one or more aspects of the present disclosure.

FIGS. 3 and 4 show an example of a process flow that supports collision resolution for multiple contention resolution identities in a random access procedure in accordance with one or more aspects of the present disclosure.

FIGS. 5 and 6 show block diagrams of devices that support collision resolution for multiple contention resolution identities in a random access procedure in accordance with one or more aspects of the present disclosure.

FIG. 7 shows a block diagram of a communications manager that supports collision resolution for multiple contention resolution identities in a random access procedure in accordance with one or more aspects of the present disclosure.

FIG. 8 shows a diagram of a system including a device that supports collision resolution for multiple contention resolution identities in a random access procedure in accordance with one or more aspects of the present disclosure.

FIGS. 9 and 10 show block diagrams of devices that support collision resolution for multiple contention resolution identities in a random access procedure in accordance with one or more aspects of the present disclosure.

FIG. 11 shows a block diagram of a communications manager that supports collision resolution for multiple contention resolution identities in a random access procedure in accordance with one or more aspects of the present disclosure.

FIG. 12 shows a diagram of a system including a device that supports collision resolution for multiple contention resolution identities in a random access procedure in accordance with one or more aspects of the present disclosure.

FIGS. 13 through 16 show flowcharts illustrating methods that support collision resolution for multiple contention resolution identities in a random access procedure in accordance with one or more aspects of the present disclosure.

### DETAILED DESCRIPTION

In some wireless communication systems, a user equipment (UE) may initiate a random access procedure (e.g., a random access channel (RACH) procedure) to establish a connection with a network entity. In a first part of the random access procedure, a UE may transmit a random access preamble to a network entity. In some cases, two UEs may select the same resources for transmitting a random access preamble and may transmit the associated preambles at the same time to a network entity. In such cases, the network entity may be unable to distinguish between the two preambles. Thus, the network entity may be unable to detect one or both of the preambles from the two UEs. In some examples, the network entity may be capable of decoding random access messages from both UEs. If the network entity is capable of decoding the random access messages from both the UEs, the network entity may be expected to transmit an indication of multiple collision resolution identities via a downlink message to the UEs. However, a network entity may only be capable of transmitting a single downlink message indicating a single contention resolution identity, thereby preventing the network entity from configuring both the UEs for subsequent transmissions. Therefore, at least one of the UEs may have to reperform the random access procedure which can be relatively time consuming and can result in an increase computational resource consumption and latency of communications.

The techniques of the present disclosure may describe a network entity being capable of transmitting a message indicating multiple contention resolution identities based on the network entity successfully decoding an uplink message from both a first UE and second UE. For example, the network entity may receive conflicting random access preambles from the first UE and the second UE and may be unable to decode the random access preambles separately. However, the network entity may be capable of decoding subsequent uplink transmissions (e.g., random access messages) from the first UE and the second UE after transmission of a first downlink message to the first UE and the second UE. In some examples, in accordance with the techniques of the present disclosure, the network entity may use information indicated in the respective random access messages to indicate a network identifier for each UE. Further, the network identifiers for the UEs may be based on the first UE and the second UE indicating contention resolution identities via the random access messages. In some other examples, the network entity may transmit multiple downlink messages, and each UE may monitor for a downlink message that indicates a contention resolution identity matching the indication from the random access message of the respective UE. For example, if the first UE detects a downlink message with a contention resolution identity that is unassociated with the first UE, the first UE may refrain from decoding the downlink message and may continue to monitor for a subsequent downlink message from the network entity. In another example, due to the collision of the random access messages from the first UE and the second UE, the network entity may be unable to decode the data of a random access message from a respective UE. In such examples, the network entity may transmit a retransmission request to the respective UE for retransmission of the random access message. Thus, in accordance with the techniques of the present disclosure, a network entity may be capable of connecting with multiple UEs via random access procedures even when message collisions occur, thus preventing the need for further random access procedures and consequently reducing resource consumption and latency.

Aspects of the disclosure are initially described in the context of wireless communications systems. Additional aspects of the disclosure are described with reference to wireless communications systems and process flows. Aspects of the disclosure are further illustrated by and described with reference to apparatus diagrams, system diagrams, and flowcharts that relate to collision resolution for multiple contention resolution identities in a random access procedure.

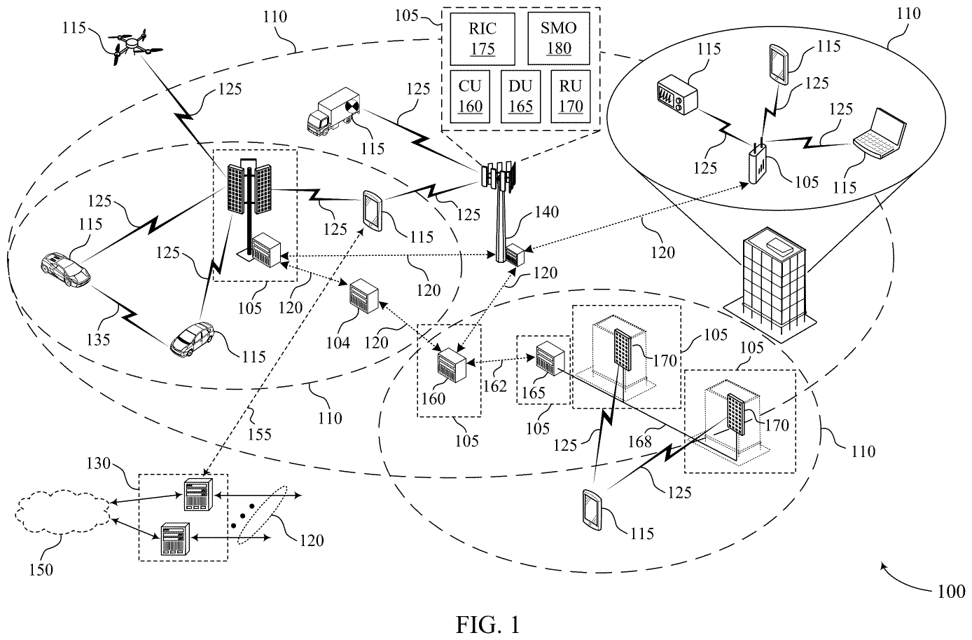

FIG. 1 shows an example of a wireless communications system 100 that supports collision resolution for multiple contention resolution identities in a random access procedure in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support collision resolution for multiple contention resolution identities in a random access procedure as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a UE 115 may initiate a random access procedure to establish a connection with a network entity 105. In a first part of the random access procedure, a UE 115 may transmit a random access preamble to a network entity 105. In some cases, two UEs 115 may select the same resources for transmitting a random access preamble and may transmit the associated preambles at the same time to a network entity 105. In such cases, the network entity 105 may be unable to distinguish between the preambles of the two UEs 115. Thus, the network entity 105 may be unable to detect both preambles transmitted by the two UEs. In some examples, the network entity 105 may be capable of decoding random access messages from both UEs 115. If the network entity 105 is capable of decoding the random access messages from both the UEs 115, the network entity 105 may be expected to transmit an indication of multiple collision resolution identities via a downlink message to the UEs 115. However, a network entity 105 may only be capable of transmitting a single downlink message indicating a single contention resolution identity, thereby preventing the network entity 105 from configuring both the UEs 115 for subsequent transmissions. Therefore, at least one of the UEs 115 may have to reperform the random access procedure which can be relatively time consuming and can result in an increase computational resource consumption and latency of communications.

The techniques of the present disclosure may describe a network entity 105 being capable of transmitting a downlink message indicating multiple contention resolution identities based on the network entity 105 successfully decoding an uplink message from both a first UE 115 and second UE 115. For example, the network entity 105 may receive conflicting random access preambles from the first UE 115 and the second UE 115 and may be unable to decode the random access preambles separately. However, the network entity 105 may be capable of decoding subsequent uplink transmissions (e.g., random access messages) from the first UE 115 and the second UE 115 after transmission of a first downlink message to the first UE 115 and the second UE 115. In some examples, in accordance with the techniques of the present disclosure, the network entity 105 may use information indicated in the respective random access messages to indicate a network identifier for each UE 115. Further, the network identifiers for the UEs 115 may be based on the first UE 115 and the second UE 115 indicating contention resolution identities via the random access messages. In some other examples, the network entity 105 may transmit multiple downlink messages, and each UE 115 may monitor for a downlink message that indicates a contention resolution identity matching the indication from the random access message of the respective UE 115. For example, if the first UE 115 detects a downlink message with a contention resolution identity that is unassociated with the first UE 115, the first UE 115 may refrain from decoding the downlink message and may continue to monitor for a subsequent downlink message from the network entity 105. In another example, due to the collision of the random access messages from the first UE 115 and the second UE 115, the network entity 105 may be unable to decode the data of a random access message from a respective UE 115. In such examples, the network entity may transmit a retransmission request to the respective UE 115 for retransmission of the random access message. Thus, in accordance with the techniques of the present disclosure, a network entity 105 may be capable of connecting with multiple UEs 115 via random access procedures even when message collisions occur, thus preventing an increase in resource consumption and latency associated with further random access procedures.

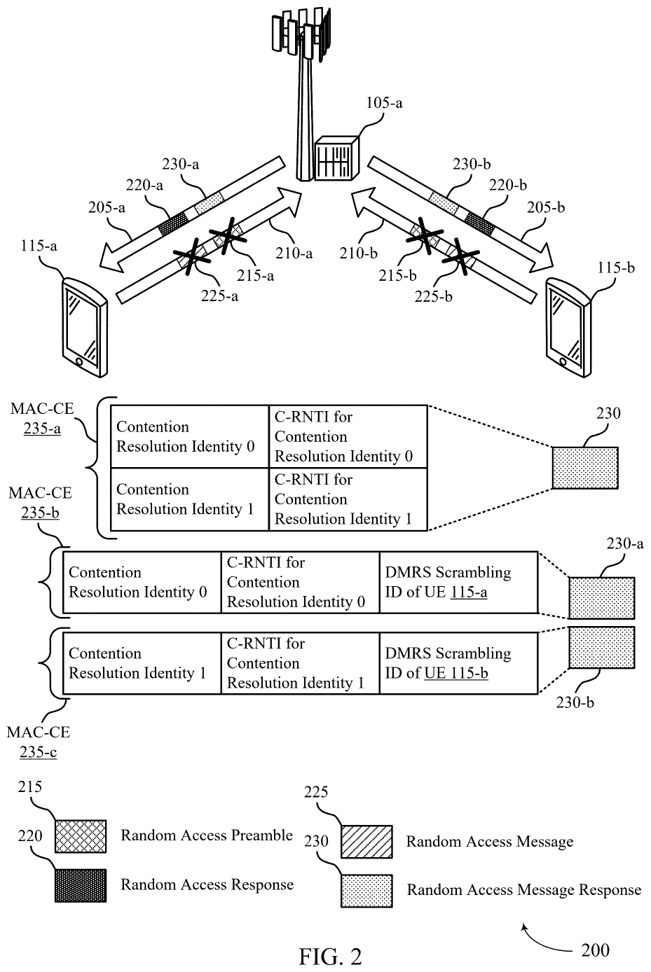

FIG. 2 shows an example of a wireless communications system 200 that supports collision resolution for multiple contention resolution identities in a random access procedure in accordance with one or more aspects of the present disclosure. In some examples, the wireless communications system 200 may implement or be implemented by the wireless communications system 100. For example, the wireless communications system 200 may include a network entity 105-a, a UE 115-a, and a UE 115-b, which may represent examples of corresponding devices described herein with reference to FIG. 1. Further, the network entity 105-a may communicate with the UE 115-a via the downlink communication link 205-a and with the UE 115-b via the downlink communication link 205-b. Moreover, the UE 115-a may communicate with the network entity 105-a via the uplink communication link 210-a and the UE 115-b may communicate with the network entity 105-a via the uplink communication link 210-b. Further, the downlink communication link 205-a, the downlink communication link 205-b, the uplink communication link 210-a, and the uplink communication link 210-b may be examples of a Uu link, a sidelink, a backhaul link, a D2D link or some other type of communication link 125 described herein with reference to FIG. 1.

In some examples of the wireless communications system 200, the UE 115-a and the UE 115-b may initiate random access procedures (e.g., RACH) procedures to establish connections with the network entity 105-a. In some cases, the random access procedure may be a four-step random access procedure or a two-step random access procedure. As a first step for the four-step random access procedure, the UE 115-a may transmit a random access preamble 215-a to the network entity 105-a via the uplink communication link 210-a and the UE 115-b may transmit a random access preamble 215-b to the network entity 105-a via the uplink communication link 210-b. In some cases, the UE 115-a and the UE 115-b may select the same resources for transmitting the random access preamble 215-a and the random access preamble 215-b. For example, the UE 115-a and the UE 115-b may select the same physical random access channel (PRACH) resources (e.g., the same random access channel occasion and preamble sequence) to transmit a PRACH message (e.g., the random access preamble 215-a and the random access preamble 215-b) at the same time. In such cases, the random access preamble 215-a and the random access preamble 215-b may collide at the network entity 105-a, thus making it relatively difficult for the network entity 105-a to distinguish between the UE 115-a and the UE 115-b.

In some examples, in response to random access preamble 215 transmissions that are conflicting, the network entity 105-a may consider a single UE 115 detected and may transmit a random access response 220 for the single detection. For example, the network entity 105-a may transmit a random access response 220-a to the UE 115-a via the downlink communication link 205-a and a random access response 220-b to the UE 115-b via the downlink communication link 205-b where the random access response 220-a and the random access response 220-b include the same uplink grant. Thus, both the UE 115-a and the UE 115-b may determine to use the uplink grant indicated in the random access response 220 for transmitting an uplink message. Moreover, the uplink grant indicated in the random access response 220 may also use the PRACH from the UE 115-a or the UE 115-b as a temporary identifier to distinguish UEs 115. However, as UE 115-a may transmit a random access message 225-a via the uplink communication link 210-a and the UE 115-b may transmit a random access message 225-b via the uplink communication link 210-b to the network entity 105-a using the same uplink grant, there may be a random access message 225 collision at the network entity 105-a.

In some cases, if the network entity 105-a calculates or determines that the signal to noise ratio (SNR) of the random access preambles 215 from the UE 115-a and the UE 115-b are within a similar range, the network entity 105-a may be unable to decode the random access message 225-a from the UE 115-a or the random access message 225-b from the UE 115-b. In such case, to mitigate the collisions, the network entity 105-a may refrain from transmitting a random access message response 230 (e.g., may refrain from transmitting a random access message response 230-a to the UE 115-a and a random access message response 230-b to the UE 115-b). Instead, after expiration of a collision resolution timer, the UE 115-a and the UE 115-b may retransmit the random access preambles 215 accordingly. In some cases, if the collision resolution timer is at the network entity 105-a, the network entity 105-a may transmit a request for retransmissions of the random access preambles 215. In some other cases, if the collision resolution timer is at a UE 115, the respective UE 115 may automatically retransmit the random access preamble 215 in response to expiration of the timer.

In some other cases, the network entity 105-a may calculate or determine that the SNR of the random access preambles 215 are within different ranges. Thus, the network entity 105-a may be able to decode the random access message 225 from the UE 115 associated with a random access preamble 215 that is relatively stronger (e.g., a random access preamble 215 with a relatively higher SNR). For example, the network entity 105-a may determine that the random access preamble 215-a from the UE 115-a is associated with a relatively higher SNR and as a result the network entity 105-a may be capable of decoding the random access message 225-a from the UE 115-a. Based on decoding the random access message 225-a from the UE 115-a, the network entity 105-a may transmit a random access message response 230 with a collision resolution identity that corresponds to the UE 115-a. Moreover, the UE 115-b may then retransmit random access message 225-b after expiration of a collision resolution timer at the UE 115-b, the network entity 105-a, or both.

In another example, the network entity 105-a may be capable of decoding multiple colliding random access message transmissions from resources allocated to a random access message 225 (e.g., the random access message 225-a or the random access message 225-b). In some cases, the network entity 105-a may decode multiple UE 115 (e.g., the UE 115-a and the UE 115-b) transmissions based on different demodulation reference signal (DMRS) scrambling from the multiple UEs 115 (e.g., similar to space division multiple access (SDMA) techniques). For example, the network entity 105-a may inform or indicate to the UEs 115 (e.g., the UE 115-a and the UE 115-b) that the UEs 115 are to select a random DMRS scrambling. In some examples, the network entity 105-a may transmit such indication via a random access response 220 (e.g., the random access response 220-a and the random access response 220-b). In some other cases, the network entity 105-a may decode multiple UE 115 transmissions through different spatial directions. For example, if the network entity 105-a is configured with digital beams, the network entity 105-a may separate the UE 115 random access message 225 transmissions using different beams. Thus, the network entity 105-a may be capable of using different beams to receive the random access message 225-a from the UE 115-a and the random access message 225-b from the UE 115-b. Thus, the network entity 105-a may be expected to transmit multiple UE 115 collision identities in the transmission of the random access message response 230.

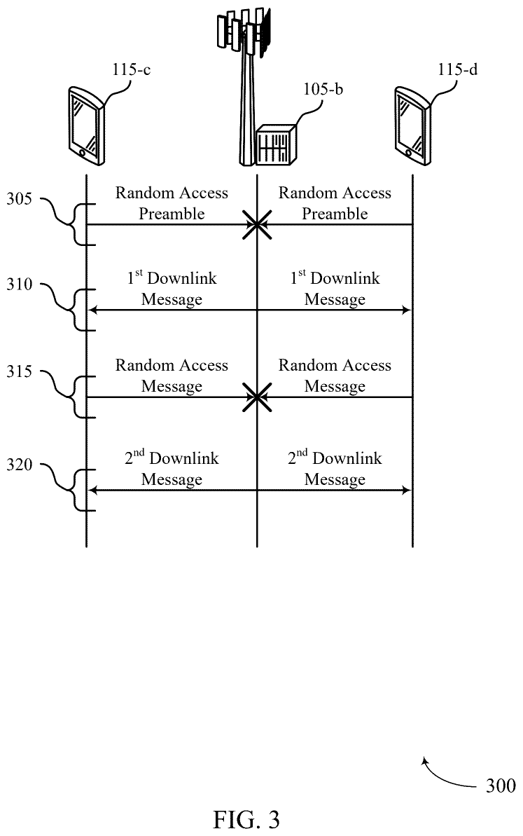

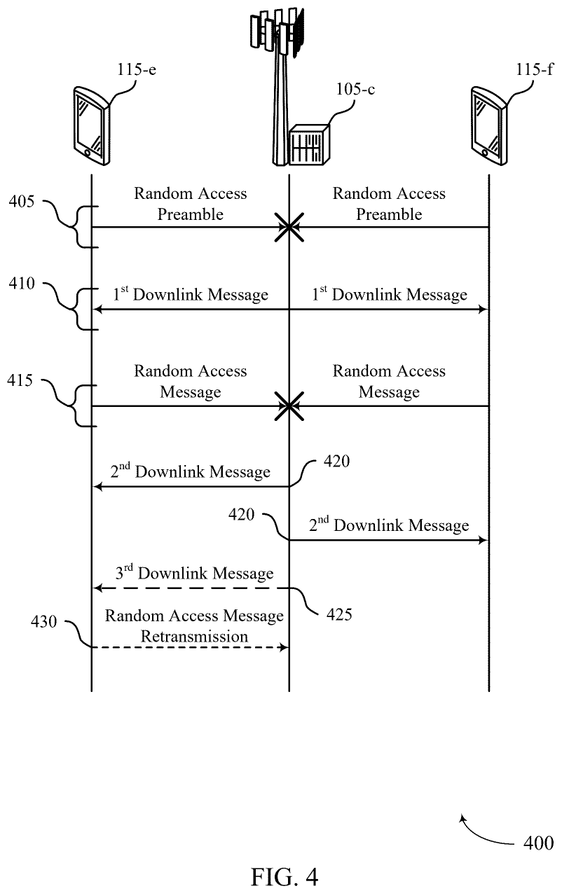

As described herein, the network entity 105-a may transmit a downlink message (e.g., the random access message response 230-a, the random access message response 230-b, or both) with multiple contention resolution identities. Further, the network entity 105-a may indicate the multiple contention resolution identities via a MAC-control element (MAC-CE) 235 (e.g., a MAC-CE 235-a, a MAC-CE 235-b, and a MAC-CE 235-c. Further descriptions of the techniques of the present disclosure may be described elsewhere herein, such as with reference to FIGS. 3 and 4. For example, FIG. 3 may describe the network entity 105-a transmitting a single downlink message (e.g., a random access message response 230 that includes the MAC-CE 235-a) including two or more radio network identifiers corresponding to two or more contention resolution identities that are associated with two or more UEs 115 (e.g., the UE 115-a and the UE 115-b). Further, FIG. 4 may describe the network entity 105-a transmitting multiple downlink messages (e.g., the random access message response 230-a including the MAC-CE 235-b and a random access message response 230-b including the MAC-CE 235-b) to indicate radio network identifiers corresponding to contention resolution identities that are associated with respective UEs 115 or transmitting retransmission requests to UEs 115 to request a retransmission of a random access message 225 from a respective UE 115.

FIG. 3 shows an example of a process flow 300 that supports collision resolution for multiple contention resolution identities in a random access procedure in accordance with one or more aspects of the present disclosure. In some examples, the process flow 300 may be implemented by the wireless communications system 100, the wireless communications system 200, or both. The process flow 300 may include a UE 115-c, a network entity 105-b, and a UE 115-d which may be examples of devices or services described elsewhere herein including with reference to FIG. 1.

In the following description of the process flow 300, the operations may be performed by the UE 115-c, the network entity 105-b, and the UE 115-d in different orders or at different times. Some operations may also be left out of the process flow 300, or other operations may be added. Although the process flow 300 may be described as being performed by the UE 115-c, the network entity 105-b, and the UE 115-d, some aspects of some operations may also be performed by other devices, services, or models described elsewhere herein including with reference to FIGS. 1 through 2.

At 305, the UE 115-c and the UE 115-d may transmit, to the network entity 105-b, a random access preamble via a random access occasion. Moreover, the UE 115-c and the UE 115-d may transmit the random access preambles to the network entity 105-b at the same time, thus the random access preambles may collide as described elsewhere herein with reference to FIG. 2. Further, as illustrated in FIGS. 3 and 4, the marking ‘X’ may represent that the messages collide at the network entity 105-b due to the UE 115-c and the UE 115-d transmitting the messages to the network entity 105-b at the same time, using the same resources, or a combination thereof. At 310, the UE 115-c and the UE 115-d may receive, from the network entity 105-a and based on transmitting the respective random access preambles, a first downlink message (e.g., a random access response 220 described with reference to FIG. 2) that indicates a temporary radio network identifier that is associated with the random access preamble. For example, the first downlink message may indicate a temporary cell radio network temporary identifier (TC-RNTI) via the first downlink message.

At 315, the UE 115-c and the UE 115-d may transmit, to the network entity 105-b and based on reception of the first downlink message, respective random access messages (e.g., the random access message 225 described with reference to FIG. 2). The random access messages may include the temporary radio network identifier (e.g., TC-RNTI) indicated via the first downlink message received at 310 and include information associated with a contention resolution identity associated with the respective UE 115 (e.g., the information including an index of a contention resolution identity, an uplink common control channel (CCCH) service data unit (SDU), a unique identifier of the UE 115 for conflict resolution, or a combination thereof). In some cases, as illustrated herein, the random access messages from the UE 115-c and the UE 115-d may collide at the network entity 105-b. However, as described with reference to FIG. 2, the network entity 105-b may be capable of decoding both the random access messages from the UE 115-c and the UE 115-d separately.

At 320, the UE 115-c and the UE 115-d may receive, from the network entity 105-b and based on transmission of the random access message, a second downlink message. The second downlink message may include two or more radio network identifiers (e.g., cell radio network temporary identifiers (C-RNTIs) that may be used for subsequent transmissions from UEs) corresponding to two or more contention resolution identities. Further, a first radio network identifier of the two or more radio network identifiers may correspond to a first contention resolution identity of the two or more contention resolution identities. Moreover, the first radio network identifier may be associated with a respective UE 115 (e.g., the UE 115-c or the UE 115-d) based on the first contention resolution identity being associated with the information indicated via the respective random access message. In some cases, the UE 115-c and the UE 115-d may receive the second downlink message based on monitoring for a respective downlink message that is associated with the temporary radio network identifier (e.g., the TC-RNTI). Thus, the UE 115-c and the UE 115-d may receive the second downlink message based on the second downlink message being associated with the temporary radio network identifier indicated via the first downlink message and included by the UE 115-c and the UE 115-d in the random access messages transmitted at 315.

In some examples, the second downlink message may be a downlink control information (DCI) message. Further, the second downlink message may include or indicate a MAC-CE (e.g., in a PDSCH message) via the DCI message. Thus, the UE 115-c and the UE 115-d may decode the MAC-CE indicated via the second downlink message based on reception of the second downlink message (e.g., the DCI message). Moreover, at 320, the network entity 105-b may transmit a single DCI that corresponds to the TC-RNTI indicated via the first downlink message and the DCI may point or indicate a set of PDSCH resources that include multiple UE 115 contention resolution identities. Further, the MAC-CE may include different C-RNTIs, where each of the different C-RNTIs corresponds to a respective UE 115 contention resolution identity (e.g., as illustrated via the MAC-CE 235-a in FIG. 2).

For example, as the same TC-RNTI is allocated to the UE 115-c and the UE 115-d via the first downlink message due to the colliding random access preambles, the network entity 105-b may be expected to allocate a different C-RNTI for each UE 115 based on decoding the random access messages. In some cases, based on decoding the MAC-CE, the UE 115-c may identify that the C-RNTI indicated via the MAC-CE (e.g., a first C-RNTI) is for the UE 115-c based on the UE 115-c identifying that the first C-RNTI is associated with the contention resolution identity that the UE 115-c indicated via the random access message (e.g., the first contention resolution identity). Further, the UE 115-d may identify a second C-RNTI indicated via the MAC-CE is for the UE 115-d based on the UE 115-d identifying that the second C-RNTI-is associated with a second contention resolution identity based on the second contention resolution identity being associated with the information of the contention resolution identity that the UE 115-d indicated via a respective random access message. Thus, a UE 115 may identify that a C-RNTI is associated with the UE 115 based on a correspondence between one of the two or more contention resolution identities indicated via the MAC-CE and the contention resolution identity indicated by the UE 115.

Thus, after receiving and decoding the MAC-CE, each UE 115 may search for an associated contention resolution identity in the MAC-CE. Moreover, in some cases, the UE 115-c, the UE 115-d, or both may identify that a contention resolution identity and associated C-RNTI matches or corresponds to the information indicated by the respective UE 115 via the random access message transmitted at 310. As a result, the respective UE 115 may successfully receive and decode the MAC-CE. In some cases, the MAC-CE may indicate the respective contention resolution identities and C-RNTIs via a mapping within the MAC-CE, a bitmap, or any other type of indication. Additionally, or alternatively, after successfully receiving and decoding the MAC-CE, the UE 115-c and the UE 115-d may set the respective C-RNTI to its contention resolution identity for subsequent transmissions. Moreover, the UE 115-c, the UE 115-d, or both may then transmit, to the network entity 105-b, an acknowledgment message (e.g., a HARQ-acknowledgment (ACK) or a HARQ-negative ACK (NACK) message) in response to reception of the second downlink message. Further, the UE 115-c, the UE 115-d, or both may indicate, via the acknowledgment message, the first radio network identifier instead of the temporary radio network identifier based on reception of the second downlink message. In some examples, instead of the network entity 105-b indicating multiple contention resolution identities and associated C-RNTIs for multiple UEs 115 via a single DCI and MAC-CE via second downlink message, in accordance with the technologies of the present disclosure, the network entity 105-b may transmit multiple DCI messages, transmit random access message retransmission requests, or a combination thereof. Further descriptions of such techniques of the present disclosure may be described elsewhere herein, such as with reference to FIG. 4.

FIG. 4 shows an example of a process flow 400 that supports collision resolution for multiple contention resolution identities in a random access procedure in accordance with one or more aspects of the present disclosure. In some examples, the process flow 400 may be implemented by the wireless communications system 100, the wireless communications system 200, or both. The process flow 400 may include a UE 115-e, a network entity 105-c, and a UE 115-f which may be examples of devices or services described elsewhere herein including with reference to FIG. 1.

In the following description of the process flow 400, the operations may be performed by the UE 115-e, the network entity 105-c, and the UE 115-f in different orders or at different times. Some operations may also be left out of the process flow 400, or other operations may be added. Although the process flow 400 may be described as being performed by the UE 115-e, the network entity 105-c, and the UE 115-f, some aspects of some operations may also be performed by other devices, services, or models described elsewhere herein including with reference to FIGS. 1 through 2.

At 405, the UE 115-e and UE 115-f, may transmit, to the network entity 105-c, a random access preamble via a random access occasion. In some examples, as illustrated herein, the random access preamble from the UE 115-e may collide with the random access preamble from the UE 115-f. At 410, based on transmitting the random access preamble, the UE 115-e and the UE 115-f may receive, from the network entity 105-c, a first downlink message indicating a temporary radio network identifier (e.g., a TC-RNTI) that is associated with the random access preamble. Moreover, the UE 115-e and the UE 115-f may receive the same downlink message indicating the same TC-RNTI.

At 415, based on reception of the first downlink message, the UE 115-e and the UE 115-f may transmit, to the network entity 105-c, a random access message that includes the temporary radio network identifier (e.g., the TC-RNTI) indicated via the first downlink message and information associated with a contention resolution identity associated with the respective UE 115 (e.g., the UE 115-e or the UE 115-f). Moreover, the random access message from the UE 115-e may collide with the random access message from the UE 115-f and the network entity 105-c may be capable of decoding both random access messages.

At 420, based on the UE 115-e and the UE 115-f transmitting the random access message, the network entity 105-c may transmit, to the UE 115-e, the UE 115-f, or both, a second downlink message. In some examples, the network entity 105-c may transmit multiple downlink messages (e.g., multiple second downlink messages or random access message responses) using multiple DCI messages. Further, each DCI message may include or indicate (e.g., in a PDSCH message) a MAC-CE corresponding to a single contention resolution identity (e.g., as illustrated via the MAC-CE 235-b and the MAC-CE 235-c in FIG. 2). Moreover, a cyclic redundancy check (CRC) of each DCI transmitted from the network entity 105-c may be scrambled with the same TC-RNTI. Moreover, the MAC-CE for each second downlink message may include a C-RNTI for a UE 115 to use for subsequent transmissions. Additionally, or alternatively, the UE 115-e, the UE 115-f, or both, may receive, via the second downlink message, an indication of a reference signal scrambling identifier. For example, the MAC-CE for each UE 115 may include a DMRS scrambling identifier that was used for the transmission of the random access message from each respective UE 115.

Thus, the network entity 105-c may transmit a DCI and corresponding MAC-CE for each UE 115 such that the MAC-CE indicates a C-RNTI and a contention resolution identity for each respective UE 115. Moreover, the UE 115-e and the UE 115-f may monitor for the DCIs corresponding to the TC-RNTI from the first downlink message to decode the corresponding MAC-CE. In some examples, when monitoring the DCIs, the UE 115-f may determine whether a respective DCI message corresponds to a respective RNTI (e.g., a TC-RNTI or a C-RNTI) by checking whether the CRC of the respective DCI message is scrambled by the respective RNTI. For example, a DCI message may have a CRC portion for error handling such that a DCI message includes a set of CRC bits and the CRC bits may be masked with a respective RNTI such that the UE 115-f can determine which UE 115 the DCI message is for and the usage of the DCI message. Moreover, in some examples, the CRC bits may be at the beginning of the DCI message, the end of the DCI message, both the beginning and the end of the DCI message, or interleaved within the data bits of the DCI message.

In some cases, if the contention resolution identifier in the MAC-CE matches the information indicated within the random access message from a respective UE 115, the respective UE 115 may be capable of successfully decoding the second downlink message. In such cases, the UE 115 may then set the C-RNTI to the radio network identifier indicated via the second downlink message. Additionally, or alternatively, the UE 115 may transmit, to the network entity 105-c, an acknowledgment message indicating successful reception of the second downlink message. In some other cases, if the UE 115 identifies a contention resolution identity mismatch, DMRS scrambling identifier mismatch, or both, the UE 115 may continue to monitor for DCI corresponding to the TC-RNTI until a contention resolution timer has expired. For example, the UE 115-e (e.g., a first UE 115) may receive the second downlink message and the second downlink message may include a first radio network identifier (e.g., a C-RNTI) corresponding to a first contention resolution identity that is associated with the UE 115-f (e.g., a second UE 115 that is different from the first UE 115). Further, the second downlink message being associated with the UE 115-f may indicate for the UE 115-e to monitor for a third downlink message.

Thus, at 425, in response to the second downlink message including a respective radio network identifier corresponding to a respective contention resolution identity that is unassociated with the UE 115-e (e.g., the first radio network identifier corresponding to the first contention resolution identity that is associated with the UE 115-f), the UE 115-e may monitor for the third downlink message. Further, based on the monitoring, the UE 115-e may receive the third downlink message that includes a second radio network identifier corresponding to a second contention resolution identity that is associated with the UE 115-e. Moreover, the second radio network identifier corresponding to a second contention resolution identity may be associated with the UE 115-e based on the second contention resolution identity being associated with the information indicated via the random access message from the UE 115-e. In response to the receiving the third downlink message, the UE 115-e may transmit, to the network entity 105-c, an acknowledgment message indicating the second radio network identifier (e.g., the C-RNTI associated with the UE 115-e) instead of the temporary radio network identifier (e.g., the TC-RNTI from the first downlink message) based on reception of the third downlink message. Further, in some cases, the UE 115-e may receive, from the network entity 105-c and via the third downlink message, a MAC-CE that indicates the second radio network identifier corresponding to the second contention resolution identity that is associated with the UE 115-e. Additionally, or alternatively, in some cases, the UE 115-e may be unable to receive a respective downlink message that includes a respective radio network identifier corresponding to a respective contention resolution identity that is associated with the UE 115-e. Based on expiration of the timer the UE 115-e may transmit, to the network entity 105-c, an additional random access preamble or a retransmission of the random access preamble transmitted at 450. Additionally, or alternatively, the UE 115-e may transmit, to the network entity 105-c, an indication of an expiration of a contention resolution timer.

Further, in some cases, since each respective random access message response from the network entity 105-c (e.g., each downlink message after the random access messages) may be for different UEs 115 and correspond to different contention resolution identities and C-RNTIs, the UEs 115 may refrain from jointly processing the multiple random access response messages. For example, the network entity 105-c may transmit the multiple random access response messages through different beam directions, or the network entity 105-c may require additional processing time to decode a respective random access message. Therefore, the UE 115-e and the UE 115-f may process each random access response message separately to identify whether the downlink message is associated with the respective UE 115. Moreover, in accordance with the techniques of the present disclosure, the respective UEs 115 may continue to monitor for subsequent downlink messages if a contention resolution identity mismatch is detected, rather than automatically retransmitting a random access preamble. Thus, the techniques of the present disclosure may reduce the time consumption and power consumption of random access procedures and may result in a UE 115 connecting with the network entity 105-c relatively faster thus reducing the latency of communications and increasing the efficiency and reliability of the wireless communications system.

In some examples, at 415, the network entity 105-c may be unable to decode both the random access message from the UE 115-e and the random access message from the UE 115-f. For example, the network entity 105-c may be capable of fully decoding the random access message from the UE 115-f and may be capable of at least partially decoding the random access message from the UE 115-e. In some cases, partially decoding the random access message from the UE 115-e may include the network entity 105-c detecting DMRS of some of the transmission from the UE 115-e and the network entity 105-c being unable to decode the data of the random access message from the UE 115-e. For example, the network entity 105-c may detect the DMRS of some of the UE 115-e transmissions through scrambling or through different spatial beams but may be unable to decode the data of the random access message due to interference.

In such cases, at 420, the UE 115-e may receive, based on transmission of the random access message and from the network entity 105-c, a second downlink message that includes a request for a retransmission of the random access message. In some examples, when the second downlink message includes a request for the retransmission of the random access message, the UE 115-e may receive, from the network entity 105-c and via the second downlink message, an indication of a set of resources for transmission of the retransmission of the random access message. For example, for UEs 115 (e.g., the UE 115-e) where the network entity 105-c detects DMRSs and is unable to decode data from a random access message, the network entity 105-c may transmit a separate DCI with a resource allocation for the retransmission of the random access message.

In some other examples, the UE 115-e may receive, from the network entity 105-c and via the second downlink message, an indication of a reference signal scrambling identifier for inclusion in the retransmission of the random access message. Moreover, the reference signal scrambling identifier indicated via the second downlink message may be a DMRS scrambling identifier. For example, the network entity 105-c may indicate the detected DMRS scrambling identifier in the second downlink message such that the UE 115-e that used the same DMRS scrambling identifier for transmitting the random access message will retransmit the random access message. Thus, if the UE 115-f receives the retransmission request, the UE 115-f may refrain from performing the retransmission or may ignore the request due to a DMRS scrambling identifier mismatch.

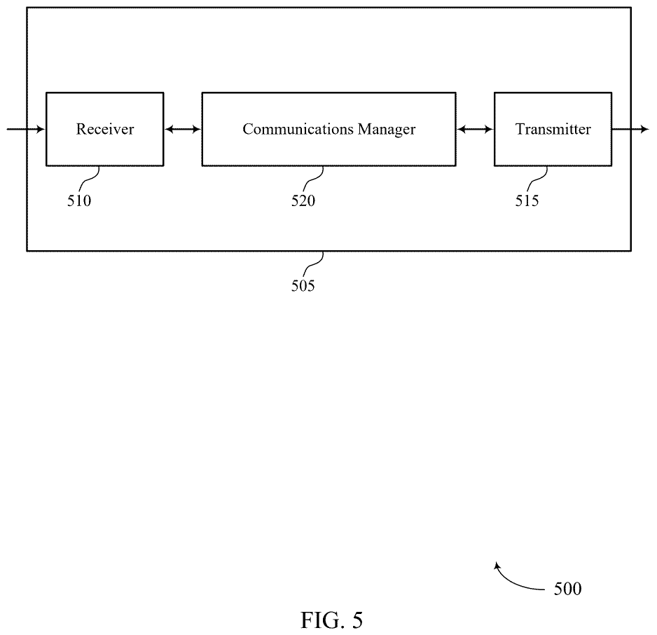

Therefore, at 430, the UE 115-e may transmit, to the network entity 105-c and in response to the second downlink message, the retransmission of the random access message based on the request for the retransmission. In some cases, based on the second downlink message indicating resources for the retransmission, the UE 115-e may transmit the retransmission of the random access message via the set of resources indicated in the second downlink message. In some other cases, based on the second downlink message indicating a reference signal scrambling identifier (e.g., DMRS scrambling identifier), the UE 115-e may include the indicated reference signal scrambling identifier in the retransmission of the random access message. Additionally, or alternatively, absent reception of the second downlink message, a respective UE 115 may continue to monitor for a DCI until a successful reception of the second downlink message, reception of a retransmission request, or until an expiration of a contention resolution timer. Thus, the techniques of the present disclosure may enable UEs 115 to more efficiently and reliably perform random access procedures to prevent an increase in communication latencies, thus resulting in a relatively more efficient and reliable wireless communications system. Further techniques of the present disclosure may be described elsewhere herein, such as with reference to FIGS. 5 through 10.

FIG. 5 shows a block diagram 500 of a device 505 that supports collision resolution for multiple contention resolution identities in a random access procedure in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to collision resolution for multiple contention resolution identities in a random access procedure). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to collision resolution for multiple contention resolution identities in a random access procedure). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of collision resolution for multiple contention resolution identities in a random access procedure as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, to a network entity, a random access preamble via a random access occasion. The communications manager 520 is capable of, configured to, or operable to support a means for receiving, based on transmission of the random access preamble, a first downlink message that indicates a temporary radio network identifier that is associated with the random access preamble. The communications manager 520 is capable of, configured to, or operable to support a means for transmitting, based on reception of the first downlink message, a random access message that includes the temporary radio network identifier and information associated with a contention resolution identity associated with the UE. The communications manager 520 is capable of, configured to, or operable to support a means for receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 520 may support wireless communications in accordance with examples as disclosed herein. For example, the communications manager 520 is capable of, configured to, or operable to support a means for transmitting, to a network entity, a random access preamble via a random access occasion. The communications manager 520 is capable of, configured to, or operable to support a means for receiving, based on transmission of the random access preamble, a first downlink message indicating a temporary radio network identifier that is associated with the random access preamble. The communications manager 520 is capable of, configured to, or operable to support a means for transmitting, based on reception of the first downlink message, a random access message that includes the temporary radio network identifier and information associated with a contention resolution identity associated with the first UE. The communications manager 520 is capable of, configured to, or operable to support a means for receiving, based on transmission of the random access message, a second downlink message that includes a first radio network identifier corresponding to a first contention resolution identity that is associated with a second UE that is different from first UE or includes a request for a retransmission of the random access message.

By including or configuring the communications manager 520 in accordance with examples as described herein, the device 505 (e.g., at least one processor controlling or otherwise coupled with the receiver 510, the transmitter 515, the communications manager 520, or a combination thereof) may support collision resolution techniques for multiple contention resolution identities in a random access procedure to support reduced processing, reduced power consumption, and more efficient utilization of communication resources.

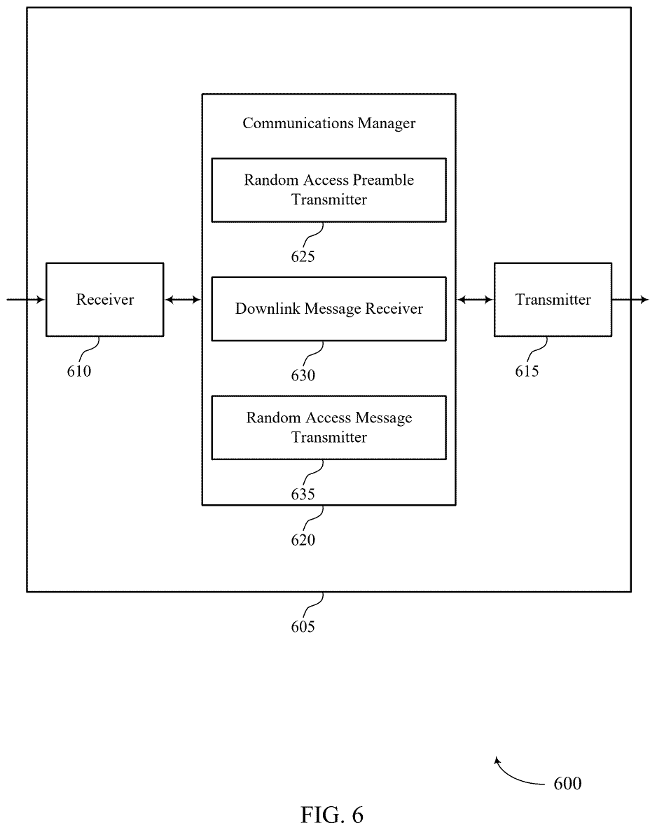

FIG. 6 shows a block diagram 600 of a device 605 that supports collision resolution for multiple contention resolution identities in a random access procedure in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to collision resolution for multiple contention resolution identities in a random access procedure). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to collision resolution for multiple contention resolution identities in a random access procedure). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of collision resolution for multiple contention resolution identities in a random access procedure as described herein. For example, the communications manager 620 may include a random access preamble transmitter 625, a downlink message receiver 630, a random access message transmitter 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The random access preamble transmitter 625 is capable of, configured to, or operable to support a means for transmitting, to a network entity, a random access preamble via a random access occasion. The downlink message receiver 630 is capable of, configured to, or operable to support a means for receiving, based on transmission of the random access preamble, a first downlink message that indicates a temporary radio network identifier that is associated with the random access preamble. The random access message transmitter 635 is capable of, configured to, or operable to support a means for transmitting, based on reception of the first downlink message, a random access message that includes the temporary radio network identifier and information associated with a contention resolution identity associated with the UE. The downlink message receiver 630 is capable of, configured to, or operable to support a means for receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 620 may support wireless communications in accordance with examples as disclosed herein. The random access preamble transmitter 625 is capable of, configured to, or operable to support a means for transmitting, to a network entity, a random access preamble via a random access occasion. The downlink message receiver 630 is capable of, configured to, or operable to support a means for receiving, based on transmission of the random access preamble, a first downlink message indicating a temporary radio network identifier that is associated with the random access preamble. The random access message transmitter 635 is capable of, configured to, or operable to support a means for transmitting, based on reception of the first downlink message, a random access message that includes the temporary radio network identifier and information associated with a contention resolution identity associated with the first UE. The downlink message receiver 630 is capable of, configured to, or operable to support a means for receiving, based on transmission of the random access message, a second downlink message that includes a first radio network identifier corresponding to a first contention resolution identity that is associated with a second UE that is different from first UE or includes a request for a retransmission of the random access message.

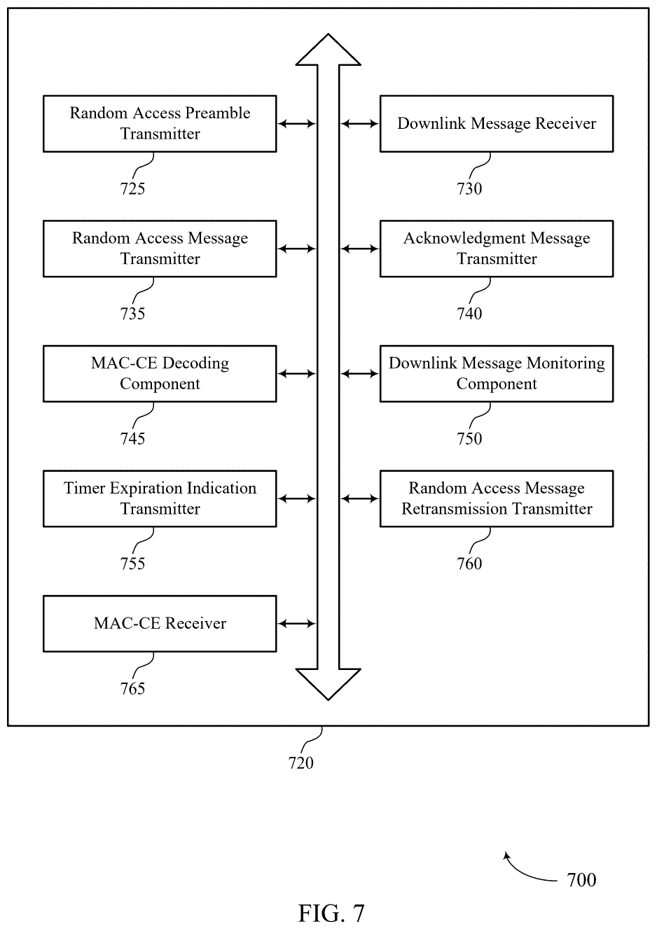

FIG. 7 shows a block diagram 700 of a communications manager 720 that supports collision resolution for multiple contention resolution identities in a random access procedure in accordance with one or more aspects of the present disclosure. The communications manager 720 may be an example of aspects of a communications manager 520, a communications manager 620, or both, as described herein. The communications manager 720, or various components thereof, may be an example of means for performing various aspects of collision resolution for multiple contention resolution identities in a random access procedure as described herein. For example, the communications manager 720 may include a random access preamble transmitter 725, a downlink message receiver 730, a random access message transmitter 735, an acknowledgment message transmitter 740, a MAC-CE decoding component 745, a downlink message monitoring component 750, a timer expiration indication transmitter 755, a random access message retransmission transmitter 760, a MAC-CE receiver 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The random access preamble transmitter 725 is capable of, configured to, or operable to support a means for transmitting, to a network entity, a random access preamble via a random access occasion. The downlink message receiver 730 is capable of, configured to, or operable to support a means for receiving, based on transmission of the random access preamble, a first downlink message that indicates a temporary radio network identifier that is associated with the random access preamble. The random access message transmitter 735 is capable of, configured to, or operable to support a means for transmitting, based on reception of the first downlink message, a random access message that includes the temporary radio network identifier and information associated with a contention resolution identity associated with the UE. In some examples, the downlink message receiver 730 is capable of, configured to, or operable to support a means for receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

In some examples, the acknowledgment message transmitter 740 is capable of, configured to, or operable to support a means for transmitting, to the network entity, an acknowledgment message in response to reception of the second downlink message, the acknowledgment message indicating the first radio network identifier instead of the temporary radio network identifier based on reception of the second downlink message.

In some examples, to support receiving the second downlink message, the downlink message receiver 730 is capable of, configured to, or operable to support a means for monitoring for a downlink message that is associated with the temporary radio network identifier, where reception of the second downlink message is based on the second downlink message being associated with the temporary radio network identifier.

In some examples, the second downlink message includes a MAC-CE, and the MAC-CE decoding component 745 is capable of, configured to, or operable to support a means for decoding the MAC-CE based on reception of the second downlink message.

In some examples, the MAC-CE indicates the two or more radio network identifiers corresponding to the two or more contention resolution identities, and the MAC-CE decoding component 745 is capable of, configured to, or operable to support a means for identifying that the first radio network identifier that corresponds to the first contention resolution identity is associated with the information based on decoding the MAC-CE.

In some examples, the second downlink message is a DCI message.

Additionally, or alternatively, the communications manager 720 may support wireless communications in accordance with examples as disclosed herein. In some examples, the random access preamble transmitter 725 is capable of, configured to, or operable to support a means for transmitting, to a network entity, a random access preamble via a random access occasion. In some examples, the downlink message receiver 730 is capable of, configured to, or operable to support a means for receiving, based on transmission of the random access preamble, a first downlink message indicating a temporary radio network identifier that is associated with the random access preamble. In some examples, the random access message transmitter 735 is capable of, configured to, or operable to support a means for transmitting, based on reception of the first downlink message, a random access message that includes the temporary radio network identifier and information associated with a contention resolution identity associated with the first UE. In some examples, the downlink message receiver 730 is capable of, configured to, or operable to support a means for receiving, based on transmission of the random access message, a second downlink message that includes a first radio network identifier corresponding to a first contention resolution identity that is associated with a second UE that is different from first UE or includes a request for a retransmission of the random access message.

In some examples, the downlink message monitoring component 750 is capable of, configured to, or operable to support a means for monitoring for a third downlink message in response to the second downlink message including the first radio network identifier corresponding to the first contention resolution identity. In some examples, the downlink message receiver 730 is capable of, configured to, or operable to support a means for receiving, based on monitoring for the third downlink message, the third downlink message that includes a second radio network identifier corresponding to a second contention resolution identity, where the first UE identifies that the second radio network identifier is associated with the first UE based on a correspondence between the contention resolution identity and the second contention resolution identity.

In some examples, the acknowledgment message transmitter 740 is capable of, configured to, or operable to support a means for transmitting, to the network entity, an acknowledgment message in response to reception of the third downlink message, the acknowledgment message indicating the second radio network identifier instead of the temporary radio network identifier based on reception of the third downlink message.

In some examples, the MAC-CE receiver 765 is capable of, configured to, or operable to support a means for receiving, via the third downlink message, a MAC-CE indicating the second radio network identifier corresponding to the second contention resolution identity that is associated with the first UE.

In some examples, the downlink message monitoring component 750 is capable of, configured to, or operable to support a means for monitoring for the third downlink message in response to the second downlink message including the first radio network identifier corresponding to the first contention resolution identity. In some examples, the timer expiration indication transmitter 755 is capable of, configured to, or operable to support a means for transmitting, to the network entity, an indication of an expiration of a contention resolution timer based on the UE being unable to receive a respective downlink message that includes a respective radio network identifier corresponding to a respective contention resolution identity that is associated with the first UE.

In some examples, the second downlink message includes the request for the retransmission of the random access message, and the random access message retransmission transmitter 760 is capable of, configured to, or operable to support a means for transmitting, to the network entity in response to the second downlink message, the retransmission of the random access message based on the request for the retransmission.

In some examples, the second downlink message includes the request for the retransmission of the random access message, and the downlink message receiver 730 is capable of, configured to, or operable to support a means for receiving, via the second downlink message, an indication of a set of resources for transmission of the retransmission of the random access message. In some examples, the second downlink message includes the request for the retransmission of the random access message, and the random access message retransmission transmitter 760 is capable of, configured to, or operable to support a means for transmitting, to the network entity in response to the second downlink message and via the set of resources indicated in the second downlink message, the retransmission of the random access message based on reception of the second downlink message.

In some examples, the second downlink message includes the request for the retransmission of the random access message, and the downlink message receiver 730 is capable of, configured to, or operable to support a means for receiving, via the second downlink message, an indication of a reference signal scrambling identifier for inclusion in the retransmission of the random access message. In some examples, the second downlink message includes the request for the retransmission of the random access message, and the random access message retransmission transmitter 760 is capable of, configured to, or operable to support a means for transmitting, to the network entity in response to the second downlink message, the retransmission of the random access message that includes the reference signal scrambling identifier indicated in the second downlink message.

In some examples, the reference signal scrambling identifier is a demodulation reference signal scrambling identifier.

In some examples, the second downlink message and the third downlink message are DCI messages.

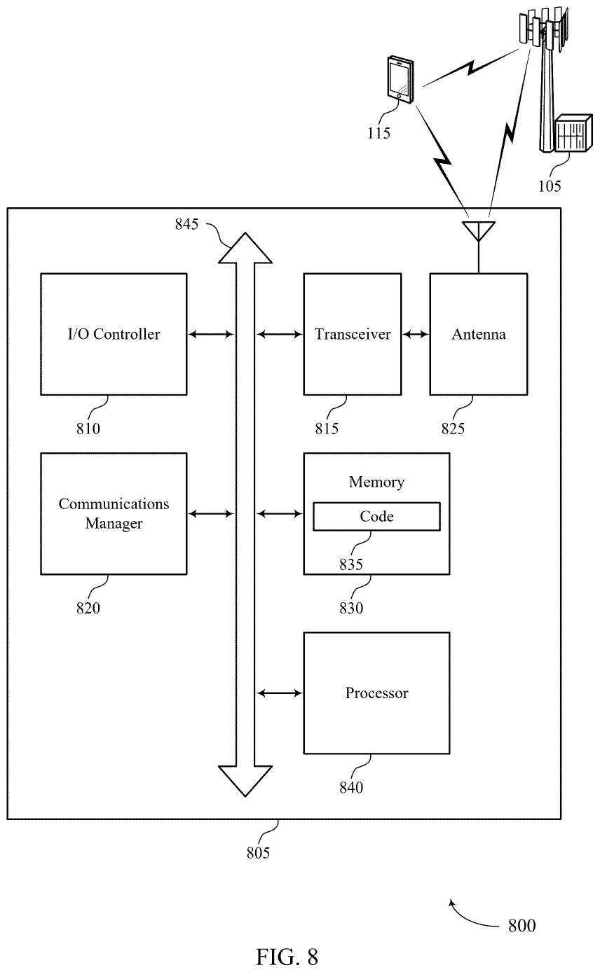

FIG. 8 shows a diagram of a system 800 including a device 805 that supports collision resolution for multiple contention resolution identities in a random access procedure in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting collision resolution for multiple contention resolution identities in a random access procedure). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, to a network entity, a random access preamble via a random access occasion. The communications manager 820 is capable of, configured to, or operable to support a means for receiving, based on transmission of the random access preamble, a first downlink message that indicates a temporary radio network identifier that is associated with the random access preamble. The communications manager 820 is capable of, configured to, or operable to support a means for transmitting, based on reception of the first downlink message, a random access message that includes the temporary radio network identifier and information associated with a contention resolution identity associated with the UE. The communications manager 820 is capable of, configured to, or operable to support a means for receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 820 may support wireless communications in accordance with examples as disclosed herein. For example, the communications manager 820 is capable of, configured to, or operable to support a means for transmitting, to a network entity, a random access preamble via a random access occasion. The communications manager 820 is capable of, configured to, or operable to support a means for receiving, based on transmission of the random access preamble, a first downlink message indicating a temporary radio network identifier that is associated with the random access preamble. The communications manager 820 is capable of, configured to, or operable to support a means for transmitting, based on reception of the first downlink message, a random access message that includes the temporary radio network identifier and information associated with a contention resolution identity associated with the first UE. The communications manager 820 is capable of, configured to, or operable to support a means for receiving, based on transmission of the random access message, a second downlink message that includes a first radio network identifier corresponding to a first contention resolution identity that is associated with a second UE that is different from first UE or includes a request for a retransmission of the random access message.

By including or configuring the communications manager 820 in accordance with examples as described herein, the device 805 may support collision resolution techniques for multiple contention resolution identities in a random access procedure to support improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of collision resolution for multiple contention resolution identities in a random access procedure as described herein, or the at least one processor 840 and the at least one memory 830 may be otherwise configured to, individually or collectively, perform or support such operations.

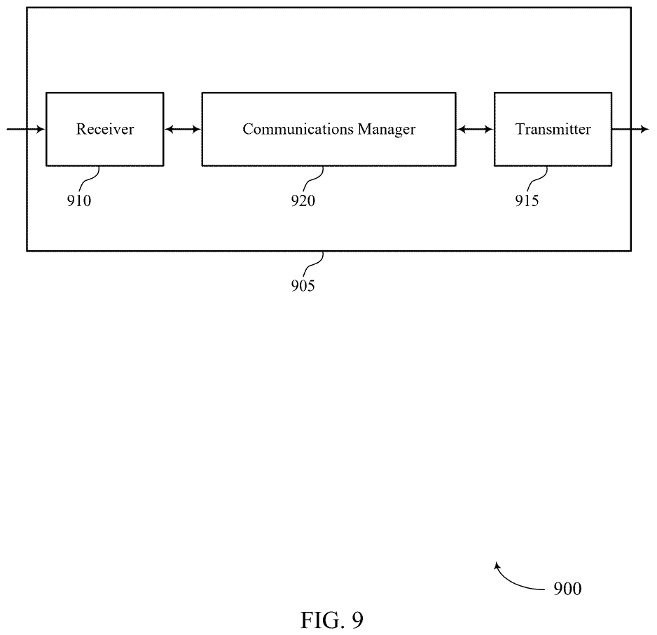

FIG. 9 shows a block diagram 900 of a device 905 that supports collision resolution for multiple contention resolution identities in a random access procedure in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of collision resolution for multiple contention resolution identities in a random access procedure as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, from a UE, a random access preamble via a random access occasion. The communications manager 920 is capable of, configured to, or operable to support a means for transmitting, based on reception of the random access preamble, a first downlink message that indicates a temporary radio network identifier that is associated with the random access preamble. The communications manager 920 is capable of, configured to, or operable to support a means for receiving, based on transmission of the first downlink message, a random access message that includes the temporary radio network identifier and information associated with a contention resolution identity associated with the UE. The communications manager 920 is capable of, configured to, or operable to support a means for transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 920 may support wireless communications in accordance with examples as disclosed herein. For example, the communications manager 920 is capable of, configured to, or operable to support a means for receiving, from a first UE, a random access preamble via a random access occasion. The communications manager 920 is capable of, configured to, or operable to support a means for transmitting, based on reception of the random access preamble, a first downlink message indicating a temporary radio network identifier that is associated with the random access preamble. The communications manager 920 is capable of, configured to, or operable to support a means for receiving, based on transmission of the first downlink message, a random access message that includes the temporary radio network identifier and information associated with a contention resolution identity associated with the first UE. The communications manager 920 is capable of, configured to, or operable to support a means for transmitting, based on reception of the random access message, a second downlink message that includes a first radio network identifier corresponding to a first contention resolution identity that is associated with a second UE that is different from first UE or includes a request for a retransmission of the random access message.

By including or configuring the communications manager 920 in accordance with examples as described herein, the device 905 (e.g., at least one processor controlling or otherwise coupled with the receiver 910, the transmitter 915, the communications manager 920, or a combination thereof) may support collision resolution techniques for multiple contention resolution identities in a random access procedure to support reduced processing, reduced power consumption, and more efficient utilization of communication resources.

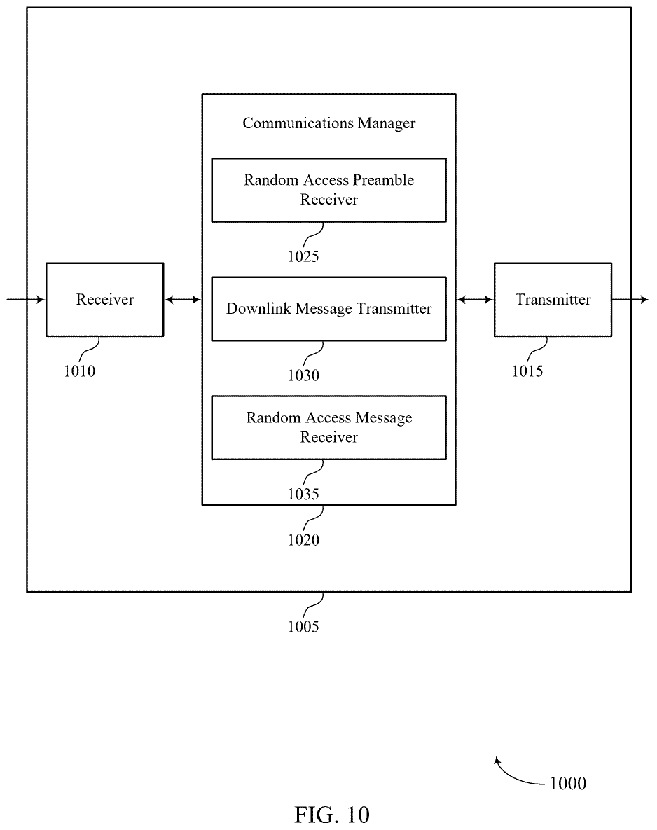

FIG. 10 shows a block diagram 1000 of a device 1005 that supports collision resolution for multiple contention resolution identities in a random access procedure in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of collision resolution for multiple contention resolution identities in a random access procedure as described herein. For example, the communications manager 1020 may include a random access preamble receiver 1025, a downlink message transmitter 1030, a random access message receiver 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The random access preamble receiver 1025 is capable of, configured to, or operable to support a means for receiving, from a UE, a random access preamble via a random access occasion. The downlink message transmitter 1030 is capable of, configured to, or operable to support a means for transmitting, based on reception of the random access preamble, a first downlink message that indicates a temporary radio network identifier that is associated with the random access preamble. The random access message receiver 1035 is capable of, configured to, or operable to support a means for receiving, based on transmission of the first downlink message, a random access message that includes the temporary radio network identifier and information associated with a contention resolution identity associated with the UE. The downlink message transmitter 1030 is capable of, configured to, or operable to support a means for transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 1020 may support wireless communications in accordance with examples as disclosed herein. The random access preamble receiver 1025 is capable of, configured to, or operable to support a means for receiving, from a first UE, a random access preamble via a random access occasion. The downlink message transmitter 1030 is capable of, configured to, or operable to support a means for transmitting, based on reception of the random access preamble, a first downlink message indicating a temporary radio network identifier that is associated with the random access preamble. The random access message receiver 1035 is capable of, configured to, or operable to support a means for receiving, based on transmission of the first downlink message, a random access message that includes the temporary radio network identifier and information associated with a contention resolution identity associated with the first UE. The downlink message transmitter 1030 is capable of, configured to, or operable to support a means for transmitting, based on reception of the random access message, a second downlink message that includes a first radio network identifier corresponding to a first contention resolution identity that is associated with a second UE that is different from first UE or includes a request for a retransmission of the random access message.

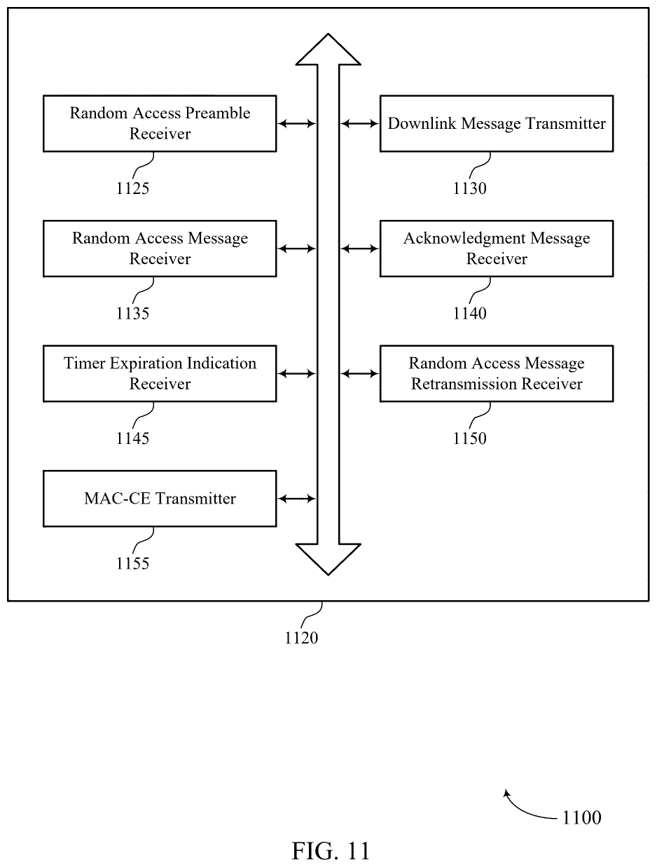

FIG. 11 shows a block diagram 1100 of a communications manager 1120 that supports collision resolution for multiple contention resolution identities in a random access procedure in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of collision resolution for multiple contention resolution identities in a random access procedure as described herein. For example, the communications manager 1120 may include a random access preamble receiver 1125, a downlink message transmitter 1130, a random access message receiver 1135, an acknowledgment message receiver 1140, a timer expiration indication receiver 1145, a random access message retransmission receiver 1150, a MAC-CE transmitter 1155, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The random access preamble receiver 1125 is capable of, configured to, or operable to support a means for receiving, from a UE, a random access preamble via a random access occasion. The downlink message transmitter 1130 is capable of, configured to, or operable to support a means for transmitting, based on reception of the random access preamble, a first downlink message that indicates a temporary radio network identifier that is associated with the random access preamble. The random access message receiver 1135 is capable of, configured to, or operable to support a means for receiving, based on transmission of the first downlink message, a random access message that includes the temporary radio network identifier and information associated with a contention resolution identity associated with the UE. In some examples, the downlink message transmitter 1130 is capable of, configured to, or operable to support a means for transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

In some examples, the acknowledgment message receiver 1140 is capable of, configured to, or operable to support a means for receiving, from the UE, an acknowledgment message in response to transmission of the second downlink message, the acknowledgment message indicating the first radio network identifier instead of the temporary radio network identifier based on transmission of the second downlink message.

In some examples, the second downlink message includes a MAC-CE.

In some examples, the MAC-CE indicates the two or more radio network identifiers corresponding to the two or more contention resolution identities.

In some examples, the second downlink message is a DCI message.

Additionally, or alternatively, the communications manager 1120 may support wireless communications in accordance with examples as disclosed herein. In some examples, the random access preamble receiver 1125 is capable of, configured to, or operable to support a means for receiving, from a first UE, a random access preamble via a random access occasion. In some examples, the downlink message transmitter 1130 is capable of, configured to, or operable to support a means for transmitting, based on reception of the random access preamble, a first downlink message indicating a temporary radio network identifier that is associated with the random access preamble. In some examples, the random access message receiver 1135 is capable of, configured to, or operable to support a means for receiving, based on transmission of the first downlink message, a random access message that includes the temporary radio network identifier and information associated with a contention resolution identity associated with the first UE. In some examples, the downlink message transmitter 1130 is capable of, configured to, or operable to support a means for transmitting, based on reception of the random access message, a second downlink message that includes a first radio network identifier corresponding to a first contention resolution identity that is associated with a second UE that is different from first UE or includes a request for a retransmission of the random access message.

In some examples, the downlink message transmitter 1130 is capable of, configured to, or operable to support a means for transmitting, based on the second downlink message including the first radio network identifier corresponding to the first contention resolution identity, a third downlink message that includes a second radio network identifier corresponding to a second contention resolution identity, where the second radio network identifier is associated with the first UE based on a correspondence between the contention resolution identity and the second contention resolution identity.

In some examples, the acknowledgment message receiver 1140 is capable of, configured to, or operable to support a means for receiving, from the first UE, an acknowledgment message in response to transmission of the third downlink message, the acknowledgment message indicating the second radio network identifier instead of the temporary radio network identifier based on reception of the third downlink message.

In some examples, the MAC-CE transmitter 1155 is capable of, configured to, or operable to support a means for transmitting, via the third downlink message, a MAC-CE indicating the second radio network identifier corresponding to the second contention resolution identity that is associated with the first UE.

In some examples, the timer expiration indication receiver 1145 is capable of, configured to, or operable to support a means for receiving, from the first UE and in response to the second downlink message including the first radio network identifier corresponding to the first contention resolution identity, an indication of an expiration of a contention resolution timer based on the UE being unable to receive a respective downlink message that includes a respective radio network identifier corresponding to a respective contention resolution identity that is associated with the first UE.

In some examples, the second downlink message includes the request for the retransmission of the random access message, and the random access message retransmission receiver 1150 is capable of, configured to, or operable to support a means for receiving, from the first UE in response to the second downlink message, the retransmission of the random access message based on the request for the retransmission.

In some examples, the second downlink message includes the request for the retransmission of the random access message, and the downlink message transmitter 1130 is capable of, configured to, or operable to support a means for transmitting, via the second downlink message, an indication of a set of resources for transmission of the retransmission of the random access message. In some examples, the second downlink message includes the request for the retransmission of the random access message, and the random access message retransmission receiver 1150 is capable of, configured to, or operable to support a means for receiving, from the first UE in response to the second downlink message and via the set of resources indicated in the second downlink message, the retransmission of the random access message based on reception of the second downlink message.

In some examples, the second downlink message includes the request for the retransmission of the random access message, and the downlink message transmitter 1130 is capable of, configured to, or operable to support a means for transmitting, via the second downlink message, an indication of a reference signal scrambling identifier for inclusion in the retransmission of the random access message. In some examples, the second downlink message includes the request for the retransmission of the random access message, and the random access message retransmission receiver 1150 is capable of, configured to, or operable to support a means for receiving, from the first UE in response to the second downlink message, the retransmission of the random access message that includes the reference signal scrambling identifier indicated in the second downlink message.

In some examples, the reference signal scrambling identifier is a DMRS scrambling identifier.

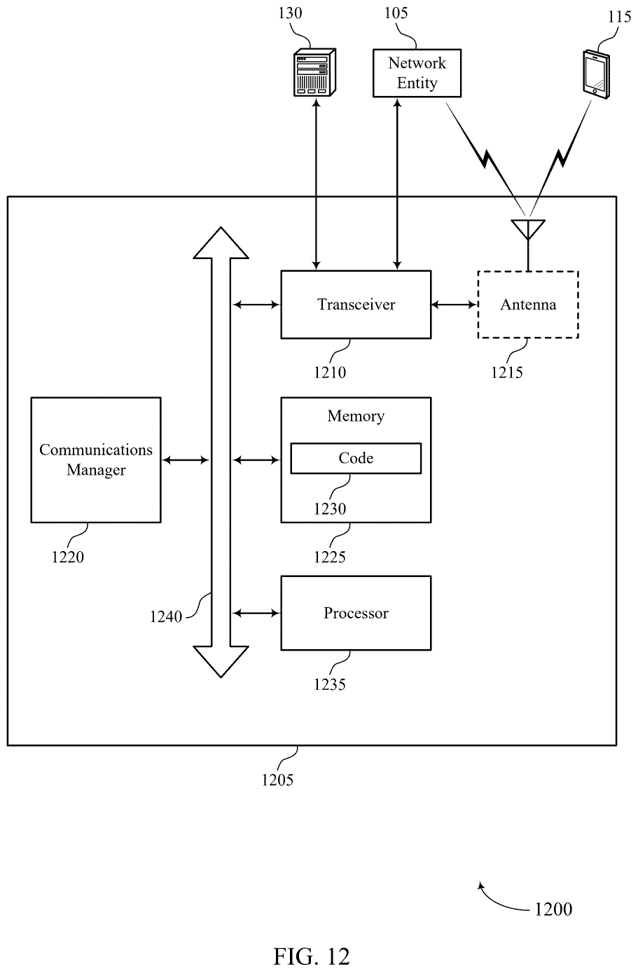

FIG. 12 shows a diagram of a system 1200 including a device 1205 that supports collision resolution for multiple contention resolution identities in a random access procedure in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting collision resolution for multiple contention resolution identities in a random access procedure). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving, from a UE, a random access preamble via a random access occasion. The communications manager 1220 is capable of, configured to, or operable to support a means for transmitting, based on reception of the random access preamble, a first downlink message that indicates a temporary radio network identifier that is associated with the random access preamble. The communications manager 1220 is capable of, configured to, or operable to support a means for receiving, based on transmission of the first downlink message, a random access message that includes the temporary radio network identifier and information associated with a contention resolution identity associated with the UE. The communications manager 1220 is capable of, configured to, or operable to support a means for transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity.

Additionally, or alternatively, the communications manager 1220 may support wireless communications in accordance with examples as disclosed herein. For example, the communications manager 1220 is capable of, configured to, or operable to support a means for receiving, from a first UE, a random access preamble via a random access occasion. The communications manager 1220 is capable of, configured to, or operable to support a means for transmitting, based on reception of the random access preamble, a first downlink message indicating a temporary radio network identifier that is associated with the random access preamble. The communications manager 1220 is capable of, configured to, or operable to support a means for receiving, based on transmission of the first downlink message, a random access message that includes the temporary radio network identifier and information associated with a contention resolution identity associated with the first UE. The communications manager 1220 is capable of, configured to, or operable to support a means for transmitting, based on reception of the random access message, a second downlink message that includes a first radio network identifier corresponding to a first contention resolution identity that is associated with a second UE that is different from first UE or includes a request for a retransmission of the random access message.

By including or configuring the communications manager 1220 in accordance with examples as described herein, the device 1205 may support collision resolution techniques for multiple contention resolution identities in a random access procedure to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of collision resolution for multiple contention resolution identities in a random access procedure as described herein, or the at least one processor 1235 and the at least one memory 1225 may be otherwise configured to, individually or collectively, perform or support such operations.

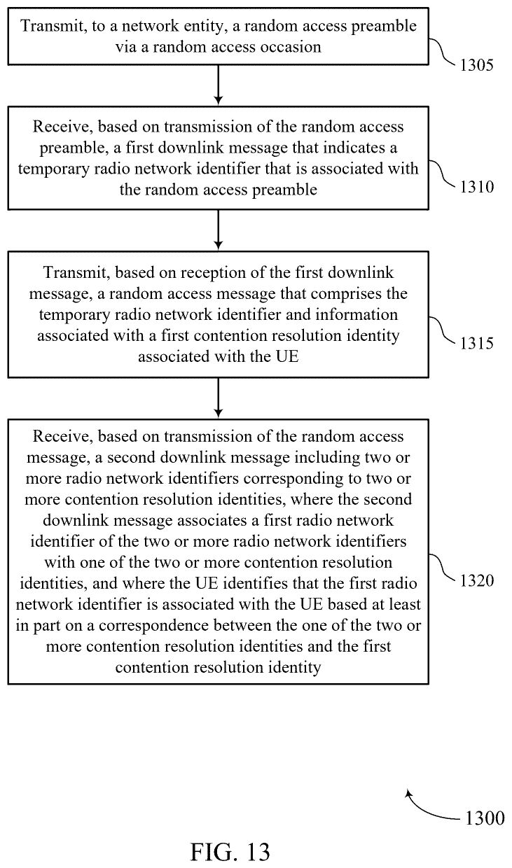

FIG. 13 shows a flowchart illustrating a method 1300 that supports collision resolution for multiple contention resolution identities in a random access procedure in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, to a network entity, a random access preamble via a random access occasion. The operations of 1305 may be performed in accordance with examples as disclosed herein. In some examples, aspects of the operations of 1305 may be performed by a random access preamble transmitter 725 as described with reference to FIG. 7.

At 1310, the method may include receiving, based on transmission of the random access preamble, a first downlink message that indicates a temporary radio network identifier that is associated with the random access preamble. The operations of 1310 may be performed in accordance with examples as disclosed herein. In some examples, aspects of the operations of 1310 may be performed by a downlink message receiver 730 as described with reference to FIG. 7.

At 1315, the method may include transmitting, based on reception of the first downlink message, a random access message that includes the temporary radio network identifier and information associated with a contention resolution identity associated with the UE. The operations of 1315 may be performed in accordance with examples as disclosed herein. In some examples, aspects of the operations of 1315 may be performed by a random access message transmitter 735 as described with reference to FIG. 7.

At 1320, the method may include receiving, based on transmission of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity. The operations of 1320 may be performed in accordance with examples as disclosed herein. In some examples, aspects of the operations of 1320 may be performed by a downlink message receiver 730 as described with reference to FIG. 7.

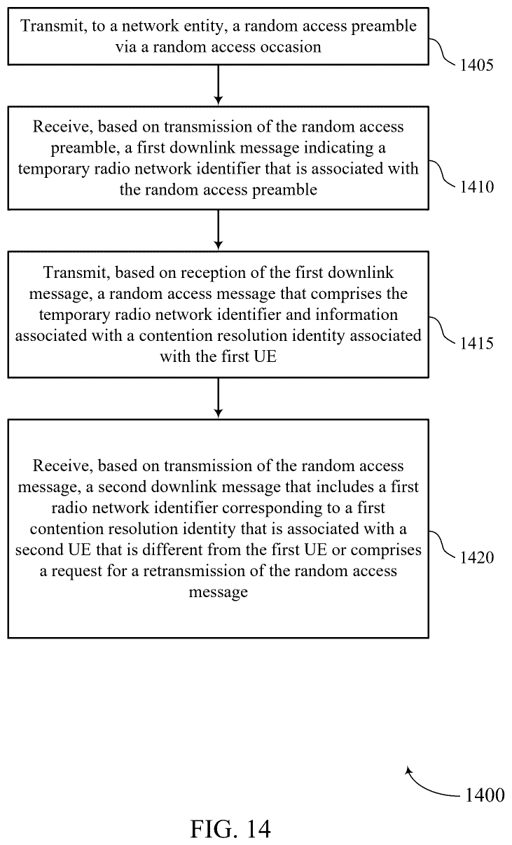

FIG. 14 shows a flowchart illustrating a method 1400 that supports collision resolution for multiple contention resolution identities in a random access procedure in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, to a network entity, a random access preamble via a random access occasion. The operations of 1405 may be performed in accordance with examples as disclosed herein. In some examples, aspects of the operations of 1405 may be performed by a random access preamble transmitter 725 as described with reference to FIG. 7.

At 1410, the method may include receiving, based on transmission of the random access preamble, a first downlink message indicating a temporary radio network identifier that is associated with the random access preamble. The operations of 1410 may be performed in accordance with examples as disclosed herein. In some examples, aspects of the operations of 1410 may be performed by a downlink message receiver 730 as described with reference to FIG. 7.

At 1415, the method may include transmitting, based on reception of the first downlink message, a random access message that includes the temporary radio network identifier and information associated with a contention resolution identity associated with the first UE. The operations of 1415 may be performed in accordance with examples as disclosed herein. In some examples, aspects of the operations of 1415 may be performed by a random access message transmitter 735 as described with reference to FIG. 7.

At 1420, the method may include receiving, based on transmission of the random access message, a second downlink message that includes a first radio network identifier corresponding to a first contention resolution identity that is associated with a second UE that is different from first UE or includes a request for a retransmission of the random access message. The operations of 1420 may be performed in accordance with examples as disclosed herein. In some examples, aspects of the operations of 1420 may be performed by a downlink message receiver 730 as described with reference to FIG. 7.

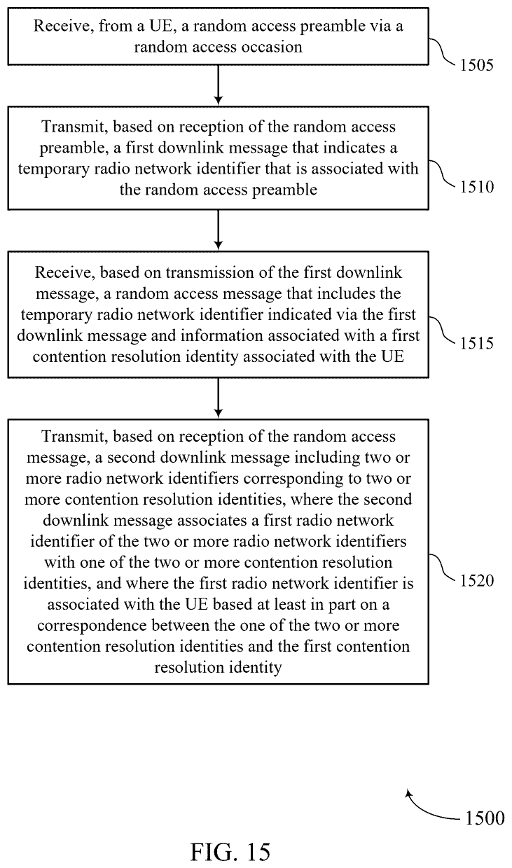

FIG. 15 shows a flowchart illustrating a method 1500 that supports collision resolution for multiple contention resolution identities in a random access procedure in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a UE, a random access preamble via a random access occasion. The operations of 1505 may be performed in accordance with examples as disclosed herein. In some examples, aspects of the operations of 1505 may be performed by a random access preamble receiver 1125 as described with reference to FIG. 11.

At 1510, the method may include transmitting, based on reception of the random access preamble, a first downlink message that indicates a temporary radio network identifier that is associated with the random access preamble. The operations of 1510 may be performed in accordance with examples as disclosed herein. In some examples, aspects of the operations of 1510 may be performed by a downlink message transmitter 1130 as described with reference to FIG. 11.

At 1515, the method may include receiving, based on transmission of the first downlink message, a random access message that includes the temporary radio network identifier and information associated with a contention resolution identity associated with the UE. The operations of 1515 may be performed in accordance with examples as disclosed herein. In some examples, aspects of the operations of 1515 may be performed by a random access message receiver 1135 as described with reference to FIG. 11.

At 1520, the method may include transmitting, based on reception of the random access message, a second downlink message including two or more radio network identifiers corresponding to two or more contention resolution identities, where the second downlink message associates a first radio network identifier of the two or more radio network identifiers with one of the two or more contention resolution identities, and where the UE identifies that the first radio network identifier is associated with the UE based on a correspondence between the one of the two or more contention resolution identities and the first contention resolution identity. The operations of 1520 may be performed in accordance with examples as disclosed herein. In some examples, aspects of the operations of 1520 may be performed by a downlink message transmitter 1130 as described with reference to FIG. 11.

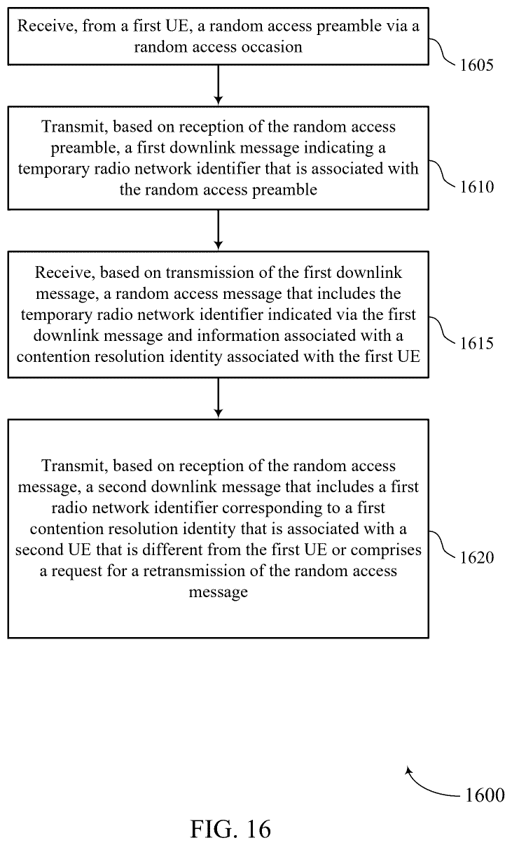

FIG. 16 shows a flowchart illustrating a method 1600 that supports collision resolution for multiple contention resolution identities in a random access procedure in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from a first UE, a random access preamble via a random access occasion. The operations of 1605 may be performed in accordance with examples as disclosed herein. In some examples, aspects of the operations of 1605 may be performed by a random access preamble receiver 1125 as described with reference to FIG. 11.

At 1610, the method may include transmitting, based on reception of the random access preamble, a first downlink message indicating a temporary radio network identifier that is associated with the random access preamble. The operations of 1610 may be performed in accordance with examples as disclosed herein. In some examples, aspects of the operations of 1610 may be performed by a downlink message transmitter 1130 as described with reference to FIG. 11.

At 1615, the method may include receiving, based on transmission of the first downlink message, a random access message that includes the temporary radio network identifier and information associated with a contention resolution identity associated with the first UE. The operations of 1615 may be performed in accordance with examples as disclosed herein. In some examples, aspects of the operations of 1615 may be performed by a random access message receiver 1135 as described with reference to FIG. 11.

At 1620, the method may include transmitting, based on reception of the random access message, a second downlink message that includes a first radio network identifier corresponding to a first contention resolution identity that is associated with a second UE that is different from first UE or includes a request for a retransmission of the random access message. The operations of 1620 may be performed in accordance with examples as disclosed herein. In some examples, aspects of the operations of 1620 may be performed by a downlink message transmitter 1130 as described with reference to FIG. 11.

The following provides an overview of aspects of the present disclosure:

Aspect 1: A method for wireless communications by a UE, comprising: transmitting, to a network entity, a random access preamble via a random access occasion; receiving, based at least in part on transmission of the random access preamble, a first downlink message that indicates a temporary radio network identifier that is associated with the random access preamble; transmitting, based at least in part on reception of the first downlink message, a random access message that comprises the temporary radio network identifier and information associated with a contention resolution identity associated with the UE; and receiving, based at least in part on transmission of the random access message, a second downlink message comprising two or more radio network identifiers corresponding to two or more contention resolution identities, wherein the second downlink message associates a first radio network identifier of the two or more radio network identifiers with one of the two or more contention resolution identities, and wherein the UE identifies that the first radio network identifier is associated with the UE based at least in part on a correspondence between the one of the two or more contention resolution identities and the first contention resolution identity.

Aspect 2: The method of aspect 1, further comprising: transmitting, to the network entity, an acknowledgment message in response to reception of the second downlink message, the acknowledgment message indicating the first radio network identifier instead of the temporary radio network identifier based at least in part on reception of the second downlink message.

Aspect 3: The method of any of aspects 1 through 2, wherein receiving the second downlink message comprises: monitoring for a downlink message that is associated with the temporary radio network identifier, wherein reception of the second downlink message is based at least in part on the second downlink message being associated with the temporary radio network identifier.

Aspect 4: The method of any of aspects 1 through 3, wherein the second downlink message comprises a MAC-CE, the method further comprising: decoding the MAC-CE based at least in part on reception of the second downlink message.

Aspect 5: The method of aspect 4, wherein the MAC-CE indicates the two or more radio network identifiers corresponding to the two or more contention resolution identities, the method further comprising: identifying that the first radio network identifier that corresponds to the first contention resolution identity is associated with the information based at least in part on decoding the MAC-CE.

Aspect 6: The method of any of aspects 1 through 5, wherein the second downlink message is a DCI message.

Aspect 7: A method for wireless communications by a first UE, comprising: transmitting, to a network entity, a random access preamble via a random access occasion; receiving, based at least in part on transmission of the random access preamble, a first downlink message indicating a temporary radio network identifier that is associated with the random access preamble; transmitting, based at least in part on reception of the first downlink message, a random access message that comprises the temporary radio network identifier and information associated with a contention resolution identity associated with the first UE; and receiving, based at least in part on transmission of the random access message, a second downlink message that comprises a first radio network identifier corresponding to a first contention resolution identity that is associated with a second UE that is different from first UE or comprises a request for a retransmission of the random access message.

Aspect 8: The method of aspect 7, further comprising: monitoring for a third downlink message in response to the second downlink message comprising the first radio network identifier corresponding to the first contention resolution identity; and receiving, based at least in part on monitoring for the third downlink message, the third downlink message that comprises a second radio network identifier corresponding to a second contention resolution identity, wherein the first UE identifies that the second radio network identifier is associated with the first UE based at least in part on a correspondence between the contention resolution identity and the second contention resolution identity.

Aspect 9: The method of aspect 8, further comprising: transmitting, to the network entity, an acknowledgment message in response to reception of the third downlink message, the acknowledgment message indicating the second radio network identifier instead of the temporary radio network identifier based at least in part on reception of the third downlink message.

Aspect 10: The method of any of aspects 8 through 9, further comprising: receiving, via the third downlink message, a MAC-CE indicating the second radio network identifier corresponding to the second contention resolution identity that is associated with the first UE.

Aspect 11: The method of any of aspects 7 through 10, further comprising: monitoring for the third downlink message in response to the second downlink message comprising the first radio network identifier corresponding to the first contention resolution identity; and transmitting, to the network entity, an indication of an expiration of a contention resolution timer based at least in part on the UE being unable to receive a respective downlink message that comprises a respective radio network identifier corresponding to a respective contention resolution identity that is associated with the first UE.

Aspect 12: The method of any of aspects 7 through 10, wherein the second downlink message and the third downlink message are DCI messages.

Aspect 13: The method of any of aspects 7 through 11, wherein the second downlink message comprises the request for the retransmission of the random access message, the method further comprising: transmitting, to the network entity in response to the second downlink message, the retransmission of the random access message based at least in part on the request for the retransmission.

Aspect 14: The method of any of aspects 7 through 12, wherein the second downlink message comprises the request for the retransmission of the random access message, the method further comprising: receiving, via the second downlink message, an indication of a set of resources for transmission of the retransmission of the random access message; and transmitting, to the network entity in response to the second downlink message and via the set of resources indicated in the second downlink message, the retransmission of the random access message based at least in part on reception of the second downlink message.

Aspect 15: The method of any of aspects 7 through 13, wherein the second downlink message comprises the request for the retransmission of the random access message, the method further comprising: receiving, via the second downlink message, an indication of a reference signal scrambling identifier for inclusion in the retransmission of the random access message; and transmitting, to the network entity in response to the second downlink message, the retransmission of the random access message that includes the reference signal scrambling identifier indicated in the second downlink message.

Aspect 16: The method of aspect 14, wherein the reference signal scrambling identifier is a DMRS scrambling identifier.

Aspect 17: A method for wireless communications by a network entity, comprising: receiving, from a UE, a random access preamble via a random access occasion; transmitting, based at least in part on reception of the random access preamble, a first downlink message that indicates a temporary radio network identifier that is associated with the random access preamble; receiving, based at least in part on transmission of the first downlink message, a random access message that comprises the temporary radio network identifier and information associated with a contention resolution identity associated with the UE; and transmitting, based at least in part on reception of the random access message, a second downlink message comprising two or more radio network identifiers corresponding to two or more contention resolution identities, wherein the second downlink message associates a first radio network identifier of the two or more radio network identifiers with one of the two or more contention resolution identities, and wherein the UE identifies that the first radio network identifier is associated with the UE based at least in part on a correspondence between the one of the two or more contention resolution identities and the first contention resolution identity.

Aspect 18: The method of aspect 17, further comprising: receiving, from the UE, an acknowledgment message in response to transmission of the second downlink message, the acknowledgment message indicating the first radio network identifier instead of the temporary radio network identifier based at least in part on transmission of the second downlink message.

Aspect 19: The method of any of aspects 17 through 18, wherein the second downlink message comprises a MAC-CE.

Aspect 20: The method of aspect 19, wherein the MAC-CE indicates the two or more radio network identifiers corresponding to the two or more contention resolution identities.

Aspect 21: The method of any of aspects 17 through 20, wherein the second downlink message is a DCI message.

Aspect 22: A method for wireless communications by a network entity, comprising: receiving, from a first UE, a random access preamble via a random access occasion; transmitting, based at least in part on reception of the random access preamble, a first downlink message indicating a temporary radio network identifier that is associated with the random access preamble; receiving, based at least in part on transmission of the first downlink message, a random access message that comprises the temporary radio network identifier and information associated with a contention resolution identity associated with the first UE; and transmitting, based at least in part on reception of the random access message, a second downlink message that comprises a first radio network identifier corresponding to a first contention resolution identity that is associated with a second UE that is different from first UE or comprises a request for a retransmission of the random access message.

Aspect 23: The method of aspect 22, further comprising: transmitting, based at least in part on the second downlink message comprising the first radio network identifier corresponding to the first contention resolution identity, a third downlink message that comprises a second radio network identifier corresponding to a second contention resolution identity, wherein the second radio network identifier is associated with the first UE based at least in part on a correspondence between the contention resolution identity and the second contention resolution identity.

Aspect 24: The method of aspect 23, further comprising: receiving, from the first UE, an acknowledgment message in response to transmission of the third downlink message, the acknowledgment message indicating the second radio network identifier instead of the temporary radio network identifier based at least in part on reception of the third downlink message.

Aspect 25: The method of any of aspects 23 through 24, further comprising: transmitting, via the third downlink message, a MAC-CE indicating the second radio network identifier corresponding to the second contention resolution identity that is associated with the first UE.

Aspect 26: The method of any of aspects 22 through 25, further comprising: receiving, from the first UE and in response to the second downlink message comprising the first radio network identifier corresponding to the first contention resolution identity, an indication of an expiration of a contention resolution timer based at least in part on the UE being unable to receive a respective downlink message that comprises a respective radio network identifier corresponding to a respective contention resolution identity that is associated with the first UE.

Aspect 27: The method of any of aspects 22 through 26, wherein the second downlink message comprises the request for the retransmission of the random access message, the method further comprising: receiving, from the first UE in response to the second downlink message, the retransmission of the random access message based at least in part on the request for the retransmission.

Aspect 28: The method of any of aspects 22 through 27, wherein the second downlink message comprises the request for the retransmission of the random access message, the method further comprising: transmitting, via the second downlink message, an indication of a set of resources for transmission of the retransmission of the random access message; and receiving, from the first UE in response to the second downlink message and via the set of resources indicated in the second downlink message, the retransmission of the random access message based at least in part on reception of the second downlink message.

Aspect 29: The method of any of aspects 22 through 28, wherein the second downlink message comprises the request for the retransmission of the random access message, the method further comprising: transmitting, via the second downlink message, an indication of a reference signal scrambling identifier for inclusion in the retransmission of the random access message; and receiving, from the first UE in response to the second downlink message, the retransmission of the random access message that includes the reference signal scrambling identifier indicated in the second downlink message.

Aspect 30: The method of aspect 29, wherein the reference signal scrambling identifier is a DMRS scrambling identifier.

Aspect 31: A UE for wireless communications, comprising one or more memories storing processor-executable code, and one or more processors coupled with the one or more memories and individually or collectively operable to execute the code to cause the UE to perform a method of any of aspects 1 through 6.

Aspect 32: A UE for wireless communications, comprising at least one means for performing a method of any of aspects 1 through 6.

Aspect 33: A non-transitory computer-readable medium storing code for wireless communications, the code comprising instructions executable by one or more processors to perform a method of any of aspects 1 through 6.

Aspect 34: A first UE for wireless communications, comprising one or more memories storing processor-executable code, and one or more processors coupled with the one or more memories and individually or collectively operable to execute the code to cause the first UE to perform a method of any of aspects 7 through 16.

Aspect 35: A first UE for wireless communications, comprising at least one means for performing a method of any of aspects 7 through 16.

Aspect 36: A non-transitory computer-readable medium storing code for wireless communications, the code comprising instructions executable by one or more processors to perform a method of any of aspects 7 through 16.

Aspect 37: A network entity for wireless communications, comprising one or more memories storing processor-executable code, and one or more processors coupled with the one or more memories and individually or collectively operable to execute the code to cause the network entity to perform a method of any of aspects 17 through 21.

Aspect 38: A network entity for wireless communications, comprising at least one means for performing a method of any of aspects 17 through 21.

Aspect 39: A non-transitory computer-readable medium storing code for wireless communications, the code comprising instructions executable by one or more processors to perform a method of any of aspects 17 through 21.

Aspect 40: A network entity for wireless communications, comprising one or more memories storing processor-executable code, and one or more processors coupled with the one or more memories and individually or collectively operable to execute the code to cause the network entity to perform a method of any of aspects 22 through 30.

Aspect 41: A network entity for wireless communications, comprising at least one means for performing a method of any of aspects 22 through 30.

Aspect 42: A non-transitory computer-readable medium storing code for wireless communications, the code comprising instructions executable by one or more processors to perform a method of any of aspects 22 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, a random access preamble via a random access occasion;
receive, based at least in part on transmission of the random access preamble, a first downlink message that indicates a temporary radio network identifier that is associated with the random access preamble;
transmit, based at least in part on reception of the first downlink message, a random access message that comprises the temporary radio network identifier and information associated with a first contention resolution identity associated with the UE; and
receive, based at least in part on transmission of the random access message, a second downlink message comprising two or more radio network identifiers corresponding to two or more contention resolution identities, wherein the second downlink message associates a first radio network identifier of the two or more radio network identifiers with one of the two or more contention resolution identities, and wherein the UE identifies that the first radio network identifier is associated with the UE based at least in part on a correspondence between the one of the two or more contention resolution identities and the first contention resolution identity.

2. The UE of claim 1, wherein the one or more processors are individually or collectively further operable to execute the code to cause the UE to:
transmit, to the network entity, an acknowledgment message in response to reception of the second downlink message, the acknowledgment message indicating the first radio network identifier instead of the temporary radio network identifier based at least in part on reception of the second downlink message.

3. The UE of claim 1, wherein, to receive the second downlink message, the one or more processors are individually or collectively operable to execute the code to cause the UE to:
monitor for a downlink message that is associated with the temporary radio network identifier, wherein reception of the second downlink message is based at least in part on the second downlink message being associated with the temporary radio network identifier.

4. The UE of claim 1, wherein the second downlink message comprises a medium access control (MAC)-control element (CE), and the one or more processors are individually or collectively further operable to execute the code to cause the UE to:
decode the MAC-CE based at least in part on reception of the second downlink message.

5. The UE of claim 4, wherein the MAC-CE indicates the two or more radio network identifiers corresponding to the two or more contention resolution identities, and the one or more processors are individually or collectively further operable to execute the code to cause the UE to:
identify that the first radio network identifier that corresponds to the first contention resolution identity is associated with the information indicated via the random access message based at least in part on decoding the MAC-CE.

6. The UE of claim 1, wherein the second downlink message is a downlink control information message.

7. A first user equipment (UE), comprising:
one or more memories storing processor-executable code; and
one or more processors coupled with the one or more memories and individually or collectively operable to execute the code to cause the first UE to:
transmit, to a network entity, a random access preamble via a random access occasion;
receive, based at least in part on transmission of the random access preamble, a first downlink message indicating a temporary radio network identifier that is associated with the random access preamble;
transmit, based at least in part on reception of the first downlink message, a random access message that comprises the temporary radio network identifier and information associated with a contention resolution identity associated with the first UE; and
receive, based at least in part on transmission of the random access message, a second downlink message that comprises a first radio network identifier corresponding to a first contention resolution identity that is associated with a second UE that is different from the first UE or comprises a request for a retransmission of the random access message.

8. The first UE of claim 7, wherein the one or more processors are individually or collectively further operable to execute the code to cause the first UE to:
monitor for a third downlink message in response to the second downlink message comprising the first radio network identifier corresponding to the first contention resolution identity; and
receive, based at least in part on monitoring for the third downlink message, the third downlink message that comprises a second radio network identifier corresponding to a second contention resolution identity, wherein the first UE identifies that the second radio network identifier is associated with the first UE based at least in part on a correspondence between the contention resolution identity and the second contention resolution identity.

9. The first UE of claim 8, wherein the one or more processors are individually or collectively further operable to execute the code to cause the first UE to:
transmit, to the network entity, an acknowledgment message in response to reception of the third downlink message, the acknowledgment message indicating the second radio network identifier instead of the temporary radio network identifier based at least in part on reception of the third downlink message.

10. The first UE of claim 8, wherein the one or more processors are individually or collectively further operable to execute the code to cause the first UE to:
receive, via the third downlink message, a medium access control (MAC)-control element (CE) indicating the second radio network identifier corresponding to the second contention resolution identity that is associated with the first UE.

11. The first UE of claim 8, wherein the one or more processors are individually or collectively further operable to execute the code to cause the first UE to:
monitor for the third downlink message in response to the second downlink message comprising the first radio network identifier corresponding to the first contention resolution identity; and
transmit, to the network entity, an indication of an expiration of a contention resolution timer based at least in part on the UE being unable to receive a respective downlink message that comprises a respective radio network identifier corresponding to a respective contention resolution identity that is associated with the first UE.

12. The first UE of claim 8, wherein the second downlink message and the third downlink message are downlink control information messages.

13. The first UE of claim 7, wherein the second downlink message comprises the request for the retransmission of the random access message, and the one or more processors are individually or collectively further operable to execute the code to cause the first UE to:
transmit, to the network entity in response to the second downlink message, the retransmission of the random access message based at least in part on the request for the retransmission.

14. The first UE of claim 7, wherein the second downlink message comprises the request for the retransmission of the random access message, and the one or more processors are individually or collectively further operable to execute the code to cause the first UE to:
receive, via the second downlink message, an indication of a set of resources for transmission of the retransmission of the random access message; and
transmit, to the network entity in response to the second downlink message and via the set of resources indicated in the second downlink message, the retransmission of the random access message based at least in part on reception of the second downlink message.

15. The first UE of claim 7, wherein the second downlink message comprises the request for the retransmission of the random access message, and the one or more processors are individually or collectively further operable to execute the code to cause the first UE to:
receive, via the second downlink message, an indication of a reference signal scrambling identifier for inclusion in the retransmission of the random access message; and
transmit, to the network entity in response to the second downlink message, the retransmission of the random access message that includes the reference signal scrambling identifier indicated in the second downlink message.

16. The first UE of claim 15, wherein the reference signal scrambling identifier is a demodulation reference signal scrambling identifier.

17. A network entity, comprising:
one or more memories storing processor-executable code; and
one or more processors coupled with the one or more memories and individually or collectively operable to execute the code to cause the network entity to:
receive, from a user equipment (UE), a random access preamble via a random access occasion;
transmit, based at least in part on reception of the random access preamble, a first downlink message that indicates a temporary radio network identifier that is associated with the random access preamble;
receive, based at least in part on transmission of the first downlink message, a random access message that comprises the temporary radio network identifier and information associated with a first contention resolution identity associated with the UE; and
transmit, based at least in part on reception of the random access message, a second downlink message comprising two or more radio network identifiers corresponding to two or more contention resolution identities, wherein the second downlink message associates a first radio network identifier of the two or more radio network identifiers with one of the two or more contention resolution identities, and wherein the first radio network identifier is associated with the UE based at least in part on a correspondence between the one of the two or more contention resolution identities and the first contention resolution identity.

18. The network entity of claim 17, wherein the one or more processors are individually or collectively further operable to execute the code to cause the network entity to:
receive, from the UE, an acknowledgment message in response to transmission of the second downlink message, the acknowledgment message indicating the first radio network identifier instead of the temporary radio network identifier based at least in part on transmission of the second downlink message.

19. The network entity of claim 17, wherein the second downlink message comprises a medium access control control element (MAC-CE).

20. The network entity of claim 19, wherein the MAC-CE indicates the two or more radio network identifiers corresponding to the two or more contention resolution identities.

21. The network entity of claim 17, wherein the second downlink message is a downlink control information message.

22. A network entity, comprising:
one or more memories storing processor-executable code; and
one or more processors coupled with the one or more memories and individually or collectively operable to execute the code to cause the network entity to:
receive, from a first user equipment (UE), a random access preamble via a random access occasion;
transmit, based at least in part on reception of the random access preamble, a first downlink message indicating a temporary radio network identifier that is associated with the random access preamble;
receive, based at least in part on transmission of the first downlink message, a random access message that comprises the temporary radio network identifier and information associated with a contention resolution identity associated with the first UE; and
transmit, based at least in part on reception of the random access message, a second downlink message that comprises a first radio network identifier corresponding to a first contention resolution identity that is associated with a second UE that is different from the first UE or comprises a request for a retransmission of the random access message.

23. The network entity of claim 22, wherein the one or more processors are individually or collectively further operable to execute the code to cause the network entity to:
transmit, based at least in part on the second downlink message comprising the first radio network identifier corresponding to the first contention resolution identity, a third downlink message that comprises a second radio network identifier corresponding to a second contention resolution identity, wherein the second radio network identifier is associated with the first UE based at least in part on a correspondence between the contention resolution identity and the second contention resolution identity.

24. The network entity of claim 23, wherein the one or more processors are individually or collectively further operable to execute the code to cause the network entity to:
receive, from the first UE, an acknowledgment message in response to transmission of the third downlink message, the acknowledgment message indicating the second radio network identifier instead of the temporary radio network identifier based at least in part on reception of the third downlink message.

25. The network entity of claim 23, wherein the one or more processors are individually or collectively further operable to execute the code to cause the network entity to:
transmit, via the third downlink message, a medium access control (MAC)-control element (CE) indicating the second radio network identifier corresponding to the second contention resolution identity that is associated with the first UE.

26. The network entity of claim 22, wherein the one or more processors are individually or collectively further operable to execute the code to cause the network entity to:
receive, from the first UE and in response to the second downlink message comprising the first radio network identifier corresponding to the first contention resolution identity, an indication of an expiration of a contention resolution timer based at least in part on the UE being unable to receive a respective downlink message that comprises a respective radio network identifier corresponding to a respective contention resolution identity that is associated with the first UE.

27. The network entity of claim 22, wherein the second downlink message comprises the request for the retransmission of the random access message, and the one or more processors are individually or collectively further operable to execute the code to cause the network entity to:
receive, from the first UE in response to the second downlink message, the retransmission of the random access message based at least in part on the request for the retransmission.

28. The network entity of claim 22, wherein the second downlink message comprises the request for the retransmission of the random access message, and the one or more processors are individually or collectively further operable to execute the code to cause the network entity to:
transmit, via the second downlink message, an indication of a set of resources for transmission of the retransmission of the random access message; and
receive, from the first UE in response to the second downlink message and via the set of resources indicated in the second downlink message, the retransmission of the random access message based at least in part on reception of the second downlink message.

29. The network entity of claim 22, wherein the second downlink message comprises the request for the retransmission of the random access message, and the one or more processors are individually or collectively further operable to execute the code to cause the network entity to:
transmit, via the second downlink message, an indication of a reference signal scrambling identifier for inclusion in the retransmission of the random access message; and
receive, from the first UE in response to the second downlink message, the retransmission of the random access message that includes the reference signal scrambling identifier indicated in the second downlink message.

30. The network entity of claim 29, wherein the reference signal scrambling identifier is a demodulation reference signal scrambling identifier.
